(19) United States
(12) Patent Application Publication
(10) Pub. No.: US 2024/0384041 A1
(43) Pub. Date: Nov. 21, 2024

(54) THERMALLY CONDUCTIVE HYDROGELS FOR ACIDIC GAS CAPTURE

(71) Applicant: COMMONWEALTH SCIENTIFIC AND INDUSTRIAL RESEARCH ORGANISATION, Acton, Australian Capital Territory (AU)

(72) Inventors: Colin WOOD, Kensington (AU); Matthew MYERS, Kensington (AU); Cameron WHITE, Kensington (AU)

(21) Appl. No.: 18/688,653

(22) PCT Filed: Sep. 1, 2022
(86) PCT No.: PCT/AU2022/051065

§ 371 Date: Mar. 1, 2024

(30) Foreign Application Priority Data
Sep. 1, 2021 (AU) 2021902835

(51) Int. Cl. C08J 3/075; B01D 53/14; B01J 20/30; C08K 3/04

(52) U.S. Cl. CPC C08J 3/075; B01D 53/1475; B01J 20/30; C08K 3/04; C08J 2379/02; C08K 2201/001; C08K 2201/005

(57) ABSTRACT

The present disclosure generally relates to thermally conductive hydrogels. In particular, the present disclosure relates to thermally conductive hydrogels comprising one or more acidic gas absorbents, which can be used to capture one or more acidic gases from gaseous streams or atmospheres. The present disclosure also relates to processes, methods, systems, uses and apparatuses comprising the thermally conductive hydrogels for capturing acidic gases from a gaseous stream or atmosphere.

### FIELD

The present disclosure generally relates to thermally conductive hydrogels. In particular, the present disclosure relates to thermally conductive hydrogels comprising one or more acidic gas absorbents, which can be used to capture one or more acidic gases from gaseous streams or atmospheres. The present disclosure also relates to processes, methods, systems, uses and apparatuses comprising the thermally conductive hydrogels for capturing acidic gases from a gaseous stream or atmosphere.

### BACKGROUND

Acidic gases such as carbon dioxide (CO₂), sulfur gases (e.g. SO₂, H₂S) can cause significant environmental pollution and health risks. There has been increasing concern about the damage caused by these contaminants, which has led to an increase demand to reduce their emission, including CO₂.

Various approaches have been used for acidic gas (e.g. CO₂) capture including the use of liquid and solid-based sorbents. Liquid based sorbents that are employed typically comprise groups that chemically react with the acidic gas, including for example hydroxide solutions which can capture CO₂ from low concentration streams. However, the rate of uptake and energy requirements to regenerate the hydroxide liquid based sorbents are challenging. In addition, many of the liquid based sorbents are also susceptible to oxidation, for example during regeneration, which present challenges in terms of long term stability, and are corrosive which limit industrial applicability.

To address this, various solid materials have been proposed including liquid sorbents supported on porous supports and porous materials such as metal organic frameworks. Whilst these materials offer lower regeneration energies compared to native hydroxide solutions, the cost of synthesis can be high and inhibit large scale production. Additionally, many of these liquid porous support materials demonstrate decreased stability over time and reduced gas absorption performance due to degradation and/or poor regeneration during acidic gas absorption/desorption. Additionally, gas absorption in such solid porous materials is often exothermic and can result in a significant and uneven temperature increase within the solid material. Such prolonged and/or uneven heat exposure due to the exothermic gas absorption reaction within the solid porous materials can limit the lifetime of the solid porous material due to thermal degradation.

There is a need for alternative or improved materials for use in acidic gas capture which are scalable for industrial application and improved performance and/or stability across one or more absorption and desorption cycles (e.g. improved regeneration).

It will be understood that any prior art publications referred to herein do not constitute an admission that any of these documents form part of the common general knowledge in the art, in Australia or in any other country.

### SUMMARY

The present inventors have undertaken research and development into hydrogels and methods for removing acidic gases from gaseous streams using hydrogels. The hydrogels can be tailored to provide control over the acidic gas absorption and desorption (i.e. regeneration) efficiency. In particular, the hydrogels can remove acidic gases (e.g. CO₂ or H₂S) from gaseous streams by absorbing the acidic gas within the hydrogel thereby removing it from the gaseous stream. The absorbed acidic gas can then be harvested (e.g. desorbed) from the hydrogel, and the regenerated hydrogel can be reused to absorb more acidic gas from the gaseous stream (e.g. recycled).

In particular, the present inventors have identified that by incorporating a thermally conductive material on or within the hydrogel, various properties of the hydrogel can be improved, including the hydrogels thermal conductivity which allows for good control over the acidic gas absorption efficiency and in some embodiments faster regeneration, for example by allowing the hydrogel to be heated efficiently and/or uniformly. According to at least some embodiments or examples described herein, such improved and/or uniform nature of the heating may also improve the lifetime of the hydrogel by allowing shorter heating cycles for desorption and as a result reduced thermal degradation. The present disclosure described herein can also be scalable for industrial application, and may find use particularly in the capture of acidic gases from natural gas streams, hydrocarbon sources, industrial effluent gas streams and/or low concentration streams (e.g. the atmosphere or closed loop systems). The present hydrogels can combine the advantages of liquids (high selectivity for acidic gases and low cost) with those of solids (low regeneration energy and high rate of uptake).

The hydrogel of the present disclosure comprises a thermally conductive material. The thermally conductive material may be a thermally conductive particulate material. The thermally conductive material may be interspersed one or within the hydrogel. The hydrogel comprises a cross-linked hydrophilic polymer. The thermally conductive material may be interspersed within the cross-linked hydrophilic polymer or may be interspersed on the surface of the hydrogel. The hydrogel may incorporate one or more acidic gas absorbents which are capable of capturing an acidic gas from a gaseous stream or atmosphere. The hydrogel may be in the form of a particulate.

In one aspect, there is provided hydrogel comprising a cross-linked hydrophilic polymer and a thermally conductive particulate material, wherein the thermally conductive particulate material is interspersed on or within the hydrogel.

In a related aspect, there is provided a hydrogel for capture of acidic gas comprising a cross-linked hydrophilic polymer and a thermally conductive particulate material, wherein the thermally conductive particulate material is interspersed on or within the hydrogel, wherein the hydrogel is in the form of a particulate and incorporates one or more acidic gas absorbents.

In one embodiment, the thermally conductive particulate material has a bulk thermal conductivity of at least 25 W/(m/K) at 25° C., for example between about 25 W/(m/K) and 2000 W/(m/K) at 25° C.

In one embodiment, the hydrogel comprises about 10% w/w to about 80% w/w of the thermally conductive particulate material based on the total weight of the hydrogel. In some embodiments, the thermally conductive particulate material is selected from one or more of a carbon based material, a conducting polymer, a metal, a metal alloy, or a metalloid or a salt thereof, for example may be selected from one or more of graphite, carbon black, carbon nanotubes, or carbon fibres.

In one embodiment, the thermally conductive particulate material is chemically inert. In a related embodiment, the thermally conductive particulate material is not chemically grafting to the cross-linked hydrophilic polymer of the hydrogel. In a related embodiment, the thermally conductive particulate material is not chemically grafting to the acidic gas absorbent.

In one embodiment, the cross-linked hydrophilic polymer comprises a hydrophilic polymer selected from polyamine, a polyacrylamide, a polyacrylate, a polyacrylic acid, or a copolymer thereof.

In an embodiment, the hydrogel is provided as a plurality of particles. In other words, the hydrogel is in the form of a particulate. In one embodiment, the hydrogel is a self-supported hydrogel (e.g. the hydrogel is able to maintain its morphology and absorptive capacity in the absence of a support material).

In an embodiment, the hydrogel comprises a liquid swelling agent. In one embodiment, the liquid swelling agent comprises at least one acidic gas absorbent for incorporating the acidic gas absorbent within the hydrogel. In one embodiment, at least one acidic gas absorbent is incorporated within the hydrogel as part of a liquid swelling agent absorbed within the hydrogel. In one embodiment, the liquid swelling agent comprises one or more functional groups capable of binding to the acidic gas by a chemical process or is a liquid capable of absorbing acidic gas by a physical process. The liquid swelling agent may be water or non-aqueous solvent, for example a polar solvent. The liquid swelling agent may also be capable of binding or dissolving an acidic gas, for example H₂S and/or CO₂. Alternatively or additionally, the cross-linked hydrophilic polymer may comprise one or more functional groups capable of binding to an acidic gas (e.g. CO₂ or H₂S), for example an amine.

In one embodiment, at least one acidic gas absorbent is incorporated within the hydrogel as one or more reactive functional groups on the cross-linked hydrophilic polymer for binding to the acidic gas.

In another aspect, there is provided a process for preparing a hydrogel described above, comprising mixing a solution comprising a hydrophilic polymer and a cross-linking agent under conditions effective to cross-link the hydrophilic polymer to form the hydrogel, and wherein the process comprises mixing a particulate material having a thermal conductivity with the hydrophilic polymer and cross-linking agent or contacting the hydrogel with a particulate material under conditions effective to intersperse the particulate material on or within the hydrogel.

In a related aspect, there is provided a process for preparing a hydrogel as described above, comprising mixing a solution comprising a hydrophilic polymer, a particulate material having a thermal conductivity and a cross-linking agent under conditions effective to cross-link the hydrophilic polymer to form the hydrogel, wherein the particulate material is interspersed on or within the hydrogel.

In another related aspect, there is provided a process for preparing a hydrogel as described above, comprising mixing a solution comprising a hydrophilic polymer and a cross-linking agent under conditions effective to cross-link the hydrophilic polymer to form the hydrogel, and wherein the process comprises contacting the hydrogel with a particulate material under conditions effective to intersperse the particulate material on or within the hydrogel.

In one embodiment, the process further comprises grinding/crushing the hydrogel to form a particulate. In a further embodiment, the hydrogel is ground/crushed prior to contact with the thermally conductive particulate material.

In another aspect, there is provided a process for preparing a hydrogel as described above, comprising mixing a solution comprising a hydrophilic polymer and a cross-linking agent under conditions effective to cross-link the hydrophilic polymer to form the hydrogel, and wherein the process comprises mixing a particulate material having a thermal conductivity with the hydrophilic polymer and cross-linking agent or contacting the hydrogel with a particulate material under conditions effective to intersperse the particulate material on or within the hydrogel, wherein the process further comprises grinding/crushing the hydrogel to form a particulate.

In another aspect, there is provided a method for removing an acidic gas from a gaseous stream or atmosphere, comprising contacting the gaseous stream or atmosphere with the hydrogel as described herein to absorb at least some of the acidic gas from the gaseous stream or atmosphere into the hydrogel.

In one embodiment, the gaseous stream or atmosphere is selected from the group consisting of combustion flue gas, a hydrocarbon gas mixture, emission from cement or steel production, biogas and ambient air. In one embodiment, the acidic gas is carbon dioxide (CO₂) or hydrogen sulfide (H₂S). In one embodiment, the gaseous stream or atmosphere is a hydrocarbon gas. In one embodiment, the gaseous stream or atmosphere is a low CO₂ concentration gaseous stream or atmosphere.

In one embodiment, the method further comprises comprises a regeneration recovery method to desorb the absorbed acidic gas from the hydrogel. In a further embodiment, the regeneration recover method comprises heating the hydrogel to desorb the absorbed acidic gas from the hydrogel. By heating the hydrogel, the thermally conductive particulate material interspersed on or within the hydrogel can increase the rate of heat transfer which can translate to more efficient regeneration and lower temperatures. The thermally conductive particles may also improve the mechanical properties of the hydrogel and help to prevent compaction. According to some embodiments or examples described herein, the thermally conductive particles allow the hydrogel to reach thermal equilibrium more efficiently during one or more absorption and desorption cycles.

In one embodiment, the method comprises: providing a chamber enclosing the hydrogel; passing a flow of the gaseous stream or atmosphere through the chamber and contacting the hydrogel to absorb at least some of the acidic gas into the hydrogel; and optionally heating the hydrogel to a temperature effective to desorb the absorbed acidic gas from the hydrogel; and optionally flushing the desorbed acidic gas from the chamber.

In another aspect, there is provided an acidic gas removal apparatus comprising a chamber enclosing a hydrogel for capture of acidic gas from a gaseous stream or atmosphere as described herein, wherein the chamber brings the gaseous stream or atmosphere into contact with the hydrogel to absorb at least some of the acidic gas into the hydrogel.

In one embodiment, the chamber comprises an inlet through which gaseous stream or atmosphere can flow to the hydrogel and an outlet through which an effluent gaseous stream or atmosphere can flow out from the hydrogel.

It will be appreciated that any one or more of the embodiments and examples described herein for the hydrogels may also apply to processes for preparing the hydrogels, methods for removing acidic gases from gaseous streams or atmospheres, and/or apparatuses described herein. Any embodiment herein shall be taken to apply mutatis mutandis to any other embodiment unless specifically stated. It will also be appreciated that other aspects, embodiments and examples of the hydrogels, processes, methods, and/or apparatuses are described herein.

It will also be appreciated that some features of the hydrogels, processes, methods, and/or apparatuses identified in some aspects, embodiments or examples as described herein may not be required in all aspects, embodiments or examples as described herein, and this specification is to be read in this context. It will also be appreciated that in the various aspects, embodiments or examples, the order of method or process steps may not be essential and may be varied.

### BRIEF DESCRIPTION OF FIGURES

Embodiments of the present disclosure are further described and illustrated as follows, by way of example only, with reference to the accompanying drawings in which:

FIG. 1A: Illustration of the fabrication and structure of a hydrogel comprising thermally conductive particulate material according to one or more embodiments, where thermally conductive particles are either added during cross-linking of the hydrophilic polymer prior to crushing or to the hydrogel particles following crushing.

FIG. 1B: Photo of hydrogel particles comprising thermally conductive particulate material interspersed on or within the hydrogel (right hand side, black) or comprising no thermally conductive particulate material (left hand side, white).

FIG. 2: Schematic of the experimental set-up for evaluating the DAC performance of the thermally conductive hydrogels. 1. Air compressor 2. Gas pressure gauge 3. Mass flow controller 4. Bubbler 5. Sample column 6. Isotopic analyzer.

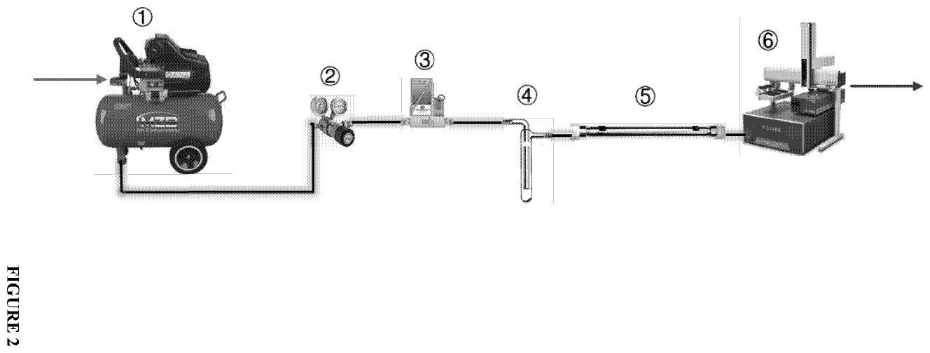

FIG. 3: Experimental set-up for evaluating the DAC performance at relatively large scale.

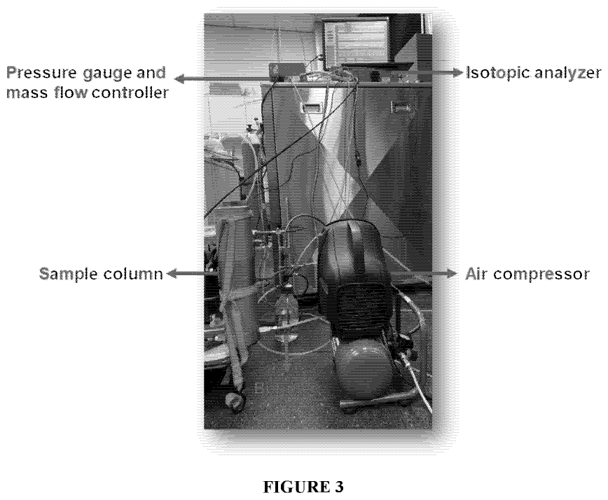

FIG. 4: CO₂ sorption curves by flowing air through a column of a PEI hydrogel comprising no graphite (top), comprising graphite (middle) and regenerated hydrogels comprising graphite (bottom).

FIG. 5: Depicts an apparatus for performing the method for capture of an acidic gas from a gaseous stream or atmosphere, according to some embodiments of the disclosure.

### DETAILED DESCRIPTION

The present disclosure describes the following various non-limiting embodiments, which relate to investigations undertaken to develop hydrogels and methods for removing acidic gases from gaseous streams using hydrogels.

### Terms

In the following description, reference is made to the accompanying drawings which form a part hereof, and which is shown, by way of illustration, several embodiments. It is understood that other embodiments may be utilized and structural changes may be made without departing from the scope of the present disclosure.

With regards to the definitions provided herein, unless stated otherwise, or implicit from context, the defined terms and phrases include the provided meanings. Unless explicitly stated otherwise, or apparent from context, the terms and phrases below do not exclude the meaning that the term or phrase has acquired by a person skilled in the relevant art. The definitions are provided to aid in describing particular embodiments, and are not intended to limit the claimed invention, because the scope of the invention is limited only by the claims. Furthermore, unless otherwise required by context, singular terms shall include pluralities and plural terms shall include the singular.

All publications discussed and/or referenced herein are incorporated herein in their entirety.

Any discussion of documents, acts, materials, devices, articles or the like which has been included in the present specification is solely for the purpose of providing a context for the present disclosure. It is not to be taken as an admission that any or all of these matters form part of the prior art base or were common general knowledge in the field relevant to the present disclosure as it existed before the priority date of each claim of this application.

Throughout this disclosure, unless specifically stated otherwise or the context requires otherwise, reference to a single step, composition of matter, group of steps or group of compositions of matter shall be taken to encompass one and a plurality (i.e., one or more) of those steps, compositions of matter, groups of steps or groups of compositions of matter. Thus, as used herein, the singular forms “a”, “an” and “the” include plural aspects unless the context clearly dictates otherwise. For example, reference to “a” includes a single as well as two or more; reference to “an” includes a single as well as two or more; reference to “the” includes a single as well as two or more and so forth.

Those skilled in the art will appreciate that the disclosure herein is susceptible to variations and modifications other than those specifically described. It is to be understood that the disclosure includes all such variations and modifications. The disclosure also includes all of the examples, steps, features, methods, hydrogels, processes, and compositions, referred to or indicated in this specification, individually or collectively, and any and all combinations or any two or more of said steps or features.

The term “and/or”, e.g., “X and/or Y” shall be understood to mean either “X and Y” or “X or Y” and shall be taken to provide explicit support for both meanings or for either meaning.

Unless otherwise indicated, the terms “first,” “second,” etc. are used herein merely as labels, and are not intended to impose ordinal, positional, or hierarchical requirements on the items to which these terms refer. Moreover, reference to a “second” item does not require or preclude the existence of lower-numbered item (e.g., a “first” item) and/or a higher-numbered item (e.g., a “third” item).

As used herein, the phrase “at least one of”, when used with a list of items, means different combinations of one or more of the listed items may be used and only one of the items in the list may be needed. The item may be a particular object, thing, or category. In other words, “at least one of” means any combination of items or number of items may be used from the list, but not all of the items in the list may be required. For example, “at least one of item A, item B, and item C” may mean item A; item A and item B; item B; item A, item B, and item C; or item B and item C. In some cases, “at least one of item A, item B, and item C” may mean, for example and without limitation, two of item A, one of item B, and ten of item C; four of item B and seven of item C; or some other suitable combination.

As used herein, the term “about”, unless stated to the contrary, typically refers to +/−10%, for example +/−5%, of the designated value.

It is to be appreciated that certain features that are, for clarity, described herein in the context of separate embodiments, may also be provided in combination in a single embodiment. Conversely, various features that are, for brevity, described in the context of a single embodiment, may also be provided separately or in any sub-combination.

Throughout the present specification, various aspects and components of the invention can be presented in a range format. The range format is included for convenience and should not be interpreted as an inflexible limitation on the scope of the invention. Accordingly, the description of a range should be considered to have specifically disclosed all the possible sub-ranges as well as individual numerical values within that range, unless specifically indicated. For example, description of a range such as from 1 to 5 should be considered to have specifically disclosed sub-ranges such as from 1 to 3, from 1 to 4, from 1 to 5, from 2 to 4, from 2 to 5, from 3 to 5 etc., as well as individual and partial numbers within the recited range, for example, 1, 2, 3, 4, 4.5 or 5, unless where integers are required or implicit from context. This applies regardless of the breadth of the disclosed range. Where specific values are required, these will be indicated in the specification.

Throughout this specification the word “comprise”, or variations such as “comprises” or “comprising”, will be understood to imply the inclusion of a stated element, integer or step, or group of elements, integers or steps, but not the exclusion of any other element, integer or step, or group of elements, integers or steps.

The reference to “substantially free” generally refers to the absence of that compound or component in the hydrogel, gaseous stream or atmosphere other than any trace amounts or impurities that may be present, for example this may be an amount by weight % in the total hydrogel, gaseous stream or atmosphere of less than about 1%, 0.1%, 0.01%, 0.001%, or 0.0001%. The hydrogels, gaseous streams or atmosphere as described herein may also include, for example, impurities in an amount by weight % in the total composition, gaseous stream or atmosphere of less than about 5%, 4%, 3%, 2%, 1%, 0.5%, 0.1%, 0.01%, 0.001%, or 0.0001%. For example, this may be an amount by vol. % in the total gaseous stream or atmosphere of less than about 5%, 4%, 3%, 2%, 1%, 0.5%, 0.1%, 0.01%, 0.001%, or 0.0001%. For example, the gaseous streams or atmospheres as described herein may also include, for example, impurities in an amount by vol. % in the total gaseous stream of less than about 5%, 4%, 3%, 2%, 1%, 0.5%, 0.1%, 0.01%, 0.001%, or 0.0001%. An example of such an impurity is the amount of methane (CH₄) that may be present in air, being present in an amount of less than 0.0005 vol. %.

The term “alkyl” or “alkylene” includes straight-chained, branched, and cyclic alkyl groups and includes both unsubstituted and substituted alkyl groups. In one example, the alkyl groups are straight-chained and/or branched, and optionally interrupted by 1-3 cyclic alkyl groups. Unless otherwise indicated, the alkyl groups typically contain from 1 to 30 carbon atoms. The alkyl groups may for example contain carbon atoms from 1 to 20, 1 to 15, 1 to 12, 1 to 10, or 1 to 8. Examples of “alkyl” as used herein include, but are not limited to, methyl, ethyl, n-propyl. n-butyl, n-pentyl, isobutyl, t-butyl, isopropyl, n-octyl, n-heptyl, ethylhexyl, cyclopentyl, cyclohexyl, cyclo heptyl, adamantyl, and norbornyl, and the like. Unless otherwise noted, alkyl groups may be mono- or polyvalent. The alkyl groups may be optionally substituted and/or optionally interrupted by one or more heteroatoms. The alkyl groups may be referred to as “-alkyl-” in relation to use as a bivalent or polyvalent linking group.

The term “cycloalkyl” represents a mono-, bicyclic, or tricyclic carbocyclic ring system of from about 3 to about 30 carbon atoms, e.g., cyclopropyl, cyclobutyl, cyclopentyl, cyclohexyl or cycloheptyl. The cycloalkyl groups may be referred to as “-cycloalkyl-” in relation to use as a bivalent or polyvalent linking group.

The term “heteroalkyl” represents an alkyl group as defined supra comprising one or more heteroatoms, for example wherein the alkyl group is interrupted with one or more (e.g. 1 to 5 or 1 to 3) heteroatoms. It will be appreciated that heteroatoms may include O, N, S, or Si. In one example the heteroatoms is O. The heteroalkyl groups may be referred to as “-heteroalkyl-” in relation to use as a bivalent or polyvalent linking group.

The term “aryl” whether used alone, or in compound words such as arylalkyl, represents: (i) an optionally substituted mono-, bicyclic or tricyclic aromatic carbocyclic moiety of about 6 to about 30 carbon atoms, such as phenyl, naphthyl, or triphenyl; or, (ii) an optionally substituted partially saturated bicyclic carbocyclic aromatic ring system in which an aryl and a cycloalkyl or cycloalkenyl group are fused together to form a cyclic structure such as a tetrahydronaphthyl ring. The aryl groups may be referred to as “-aryl-” in relation to use as a bivalent or polyvalent linking group.

The term “arylalkyl” represents a —R-aryl group where the R group is an alkyl group, and the alkyl and aryl groups are each defined supra. The arylalkyl groups may be referred to as “-arylalkyl-” in relation to use as a bivalent or polyvalent linking group.

The term “heteroarylalkyl” represents a —R-aryl group where the R group is an alkyl group, and the alkyl and aryl groups are each defined supra, which is interrupted by one or more heteroatoms and optionally substituted as described herein. The heteroarylalkyl groups may be referred to as “-heteroarylalkyl-” in relation to use as a bivalent or polyvalent linking group.

As used herein, the terms “halo” or “halogen”, whether employed alone or in compound words such as haloalkyl, means fluorine, chlorine, bromine or iodine.

As used herein, the term “haloalkyl” means an alkyl group having at least one halogen substituent, the terms “alkyl” and “halogen” being understood to have the meanings outlined above. Similarly, the term “monohaloalkyl” means an alkyl group having a single halogen substituent, the term “dihaloalkyl” means an alkyl group having two halogen substituents and the term “trihaloalkyl” means an alkyl group having three halogen substituents. Examples of monohaloalkyl groups include fluoromethyl, chloromethyl, bromomethyl, fluoromethyl, fluoropropyl and fluorobutyl groups; examples of dihaloalkyl groups include difluoromethyl and difluoroethyl groups; examples of trihaloalkyl groups include trifluoromethyl and trifluoroethyl groups.

As used herein, the term “hydroxyl” represents a —OH moiety.

As used herein, the term “carboxyl” represents a C═O moiety.

As used herein, the term “carboxylic acid” represents a —CO₂H moiety.

As used herein, the term “nitro” represents a —NO₂ moiety.

As used herein, the term “alkanolamine” represents a chemical compound that contains both hydroxyl (—OH) and amino (e.g. primary —NH₂, secondary —NHR and/or -tertiary —NR₂) functional groups on an alkane backbone.

As used herein, the term “polyamine” represents a compound having two or more amines (e.g. primary —NH₂, secondary —NHR, and/or tertiary —NR₂ amine) functional groups.

The term “polyalkylenimine” represents a compound comprising an alkylene backbone wherein one or more H atoms are substituted for an amino (e.g. primary —NH₂, secondary —NHR and/or -tertiary —NR₂) functional groups, and includes copolymers or derivatives thereof.

The term “polyacrylamide” represents a polymer comprising two or more acrylamide monomers, and includes copolymers or derivatives thereof, for example poly(acrylamide-co-acrylic acid).

The term “acrylamide” represents a compound with the chemical formula CH₂=CHCNH₂ and includes derivatives thereof, for example methacrylamide.

The term “acrylic acid” represents a compound with the formula CH₂=CHCOOH and includes derivatives thereof, for example methacrylic acid.

The term “polyacrylic acid” represents a polymer comprising two or more acrylic acid monomers, and includes copolymers or derivatives thereof, for example poly(methacrylic acid).

The term “acrylate” represents a salt, ester or conjugate base of acrylic acid. The acrylate ion is the anion CH₂=CHCOO⁻. Examples include methyl acrylate, potassium acrylate and sodium acrylate, and methyl methacrylate.

The term “polyacrylate” represents a polymer comprising two or more acrylate monomers, and includes copolymers or derivatives thereof, for example poly(2-hydroxyethylmethacrylate).

The term “glycol” represents a class of compounds comprising two or more hydroxyl (—OH) groups, wherein the hydroxyl groups are attached to a different carbon atom.

The term “polyol” represents a compound containing two or more hydroxyl (—OH) groups.

The term “piperidine” represents a compound having the formula (CH₂)₅NH.

The term “optionally substituted” means that a functional group is either substituted or unsubstituted, at any available position. The term “substituted” as referred to above or herein may include, but is not limited to, groups or moieties such as halogen, hydroxyl, amine, epoxide, nitro, carboxyl, carboxylic acid.

The term “optionally interrupted” means a chain such as an alkyl chain may be interrupted by one or more (e.g. 1 to 3) functional groups such as amine, epoxide, carboxyl, carboxylic acid, and/or one or more heteroatoms such as N, S, Si, or O, at any position in the chain, for example to provide a heteroalkyl group. In one example, “optionally interrupted” means a chain such as an alkyl chain is interrupted by one or more (e.g. 1 to 3) heteroatoms such as N, S, or O.

### Hydrogels

The present disclosure provides in some embodiments a hydrogel for capture of acidic gas, comprising a cross-linked hydrophilic polymer and a thermally conductive particulate material, wherein the thermally conductive particulate material is interspersed on or within the hydrogel, wherein the hydrogel is in the form of a particulate and incorporates one or more acidic gas absorbents. In one embodiment, at least one acidic gas absorbent is incorporated within the hydrogel as one or more reactive functional groups on the cross-linked hydrophilic polymer for binding to the acidic gas or at least one acidic gas absorbent is incorporated within the hydrogel as part of a liquid swelling agent absorbed within the hydrogel.

The term “hydrogel” refers to a three-dimensional (3D) solid network of cross-linked hydrophilic polymers that can swell and hold a large amount of water and other liquids while maintaining the structure due to chemical or physical cross-linking of individual hydrophilic polymer chains. The hydrogel comprises a cross-linked hydrophilic polymer. The absorbed water/liquid is taken into the cross-linked hydrophilic polymeric matrix of the hydrogel through hydrogen bonding rather than being contained in pores from which the fluid could be eliminated by squeezing. Unlike other more complex inorganic scaffolds and supports, such as zeolites or metal organic frameworks (MOFs), after removing the solvent the hydrogel does not retain a measurable dry state porosity.

In one embodiment, the hydrogel has a low porosity. In one embodiment, the hydrogel does not have a measurable dry state porosity. For example, the hydrogel may be essentially non-porous in the dry state. When swollen with a liquid swelling agent, the hydrogel can swell beyond the initial dry state pore volume. As a result, the porosity of the swollen hydrogel increases (i.e. the hydrogel has a “liquid” based porosity). According to some embodiments or examples described herein, when swollen with a liquid, micro channels of liquid within the hydrogel are created, resulting in the acidic gas diffusion distance being significantly reduced allowing for enhanced sorbent uptake kinetics/efficiency, giving rise to improved performance. If the liquid is removed from the hydrogel (for example by freeze drying), the hydrogel does not retain a measurable dry state porosity. In contrast, silica supports will take up liquid but do not swell beyond the dry state pore volume.

The hydrogel may be characterised by an elastic modulus. For example, the hydrogel may have an elastic modulus of between about 0.1 Pa to about 12,000 Pa. In some embodiments, the elastic modulus of the hydrogel may be at least about 0.1, 10, 30, 50, 100, 200, 500, 1,000, 2,000, 5,000, 8,000, 10,000 or 12,000 Pa. In some embodiments, the elastic modulus of the hydrogel may be less than about 12,000, 10,000, 8,000, 5,000, 2,000, 1,000, 500, 200, 100, 50, 30, 10, or 0.1 Pa. Combinations of these elastic modulus values to form various ranges are also possible, for example the elastic modulus of the hydrogel may be between about 100 Pa to about 5,000 Pa. The hydrogel may have an elastic modulus of between about 2,000 to about 5,000. In other embodiments, the elastic modulus of the hydrogel may be at least about 0.1, 10, 30, 50 or 100 Pa. In various embodiments, the elastic modulus of the hydrogel may be less than about 12,000, 10,000, 8000, or 6000 Pa. In some embodiments, the elastic modulus of the hydrogel may be between about 0.2 Pa to about 12000 Pa, about 0.2 Pa to about 10000 Pa, about 0.2 Pa to about 5000 Pa, about 1 Pa to about 12000 Pa, or about 1 Pa to about 10,000 Pa. In some embodiments, the elastic modulus of the hydrogel may be between about 10 Pa to about 12000 Pa, about 10 Pa to about 10,000 Pa, or about 100 Pa to about 10,000 Pa. In other embodiments, the elastic modulus of the hydrogel may be from between about 0.1 Pa to about 10,000 Pa, about 0.1 Pa to about 5000 Pa, about 0.1 Pa to about 1000 Pa, about 1 Pa to about 12,000 Pa, about 1 Pa to about 10,000 Pa, about 100 Pa to about 12,000 Pa, about 500 Pa to about 12000 Pa, or about 1000 Pa to about 12,000 Pa. In other embodiments, the elastic modulus of hydrogel may be between about 1 Pa to about 5000 Pa, about 10 Pa to about 5000 Pa, or about 100 Pa to about 5000 Pa. In some embodiments, the elastic modulus of the hydrogel is less than about 9,000, 5,000, or 4000 Pa.

The elastic modulus may be determined by a number of suitable techniques, including using a rheometer, for example a HR-3 Discovery Hybrid Rheometer (TA Instruments). A Rheometer can be used to control shear stress or shear strain and/or apply extensional stress or extensional strain and thereby determine mechanical properties of a hydrogel including the modulus of elasticity thereof.

The hydrogel may have a surface area of between about 0.1 and 50 m²/g, about 25 m²/g, or 2 and 10 m²/g. The surface area (in m²/g) may be at least about 0.1, 0.5, 1, 2, 3, 4, 5, 6, 7, 8, 9, 10, 15, 20, 25, 30, 35, 40, or 45. The surface area (in m²/g) may be less than about 50, 45, 40, 35, 30, 25, 20, 15, 10, 9, 8, 7, 6, 5, 4, 3, 2, or 1. The surface area may be in a range provided by any two of these upper and/or lower values. The surface area may be provided for the hydrogel in a wet or dry state. It will be appreciated that the surface area will depend on particle size. The surface area can be measured using gas sorption with nitrogen or particle size analysis through microscopy.

The hydrogel may be provided in a wide range of morphologies. Illustrative examples of suitable morphologies may include particles, beads, sheets/layers, cast blocks, cylinders, discs, porous membranes and monoliths. For example, the hydrogel may be provided as a film/coating layer, for example a gel layer where the gaseous stream is flowed thereon or through the layer. Such layers may be a provided as a rolled sheet. Alternatively, the hydrogel layer may also be provided as a monolith comprising a plurality of porous channels, wherein the gaseous stream flows through. Other layer or coating morphologies and geometries are also applicable.

In one embodiment, the hydrogel may comprise a plurality of particles i.e. the hydrogel is in the form of a particulate. The term “particle” or “particulate” refers to the form of discrete solid units. The units may take the form of flakes, fibres, agglomerates, granules, powders, spheres, pulverized materials or the like, as well as combinations thereof. The particles may have any desired shape including, but not limited to, cubic, rod like, polyhedral, spherical or semi-spherical, rounded or semi-rounded, angular, irregular, and so forth. The particle morphology can be determined by any suitable means such as optical microscopy. In one embodiment, the hydrogel may comprise a plurality of spherical or substantially spherical beads.

The hydrogel particles may be of any suitable size and/or shape and/or morphology. For spherical hydrogel particles, the particle size is the diameter of the particles. For non-spherical hydrogel particles, the particle size is the longest cross-section dimension of the particles. In some embodiments, the hydrogel particles may have a particle size in a range from about 0.01 μm to about 10,000 μm, for example from about 0.1 μm to about 5000 μm. The hydrogel particles may have a particle size of at least about 0.01, 0.1, 1, 10, 20, 50, 100, 200, 300, 400, 500, 700, 1000, 1500, 2000, 5000, 7000, or 10,000 μm. In other embodiments, the hydrogel particles may have a particle size of less than about 10,000, 7000, 5000, 2000, 1500, 1000, 700, 500, 400, 300, 200, 100, 50, 20, 10, 1, 0.1 or 0.01 μm. Combinations of these particle size values to form various ranges are also possible, for example the hydrogel particles may have a particle size of between about 0.1 μm to about 10,000 μm, between about 1 μm to about 2000 μm, between about 10 μm to about 2000 μm, between about 10 μm to about 500 μm, between about 100 μm to about 400 μm, for example between about 200 μm to about 300 μm.

The hydrogel particles may have a particle size (D₅₀) of between about 0.01 μm to about 5000 μm. The hydrogel particles may have a particle size (D₅₀) of at least about 0.01, 0.1, 1, 10, 20, 50, 100, 200, 300, 400, 500, 700, 1000, 1500, 2000, or 5000 μm. The hydrogel particles may have a particle size (D₅₀) of less than about 5000, 2000, 1500, 1000, 700, 500, 400, 300, 200, 100, 50, 20, 10, 1, 0.1 or 0.01 μm. Combinations of these D₅₀ particle size values to form various ranges are also possible, for example the hydrogel particles may have a particle size (D₅₀) of between about 0.1 μm to about 2000 μm or between about 10 μm to about 500 μm. The D₅₀ particle size is defined such that 50 volume % of the particles is present in particles having a size less than the d50 particle size.

The particle size can be determined by any means known to the skilled person, such as electron microscopy (SEM or TEM), dynamic light scattering, optical microscopy or size exclusion methods (such as graduated sieves). The hydrogel particles may have a controlled particle size and can maintain their morphology in a range of different environments and shear conditions, for example while in contact with a gaseous stream and/or moist or dry environments.

In one embodiment, the hydrogel may be self-supporting. The term ‘self-supporting’ as used herein refers to the ability of the hydrogel to maintain its morphology in the absence of a support material (e.g. scaffold) such as a porous silica, zeolite or a metal organic framework (MOF). For example, the hydrogel may comprise a plurality of particles, wherein the particles maintain their morphology in the absence of a scaffold support. The self-supported nature of the hydrogel may provide certain advantages, for example allows particles of hydrogel to be contacted with the gaseous stream using a fluidized bed reactor. Accordingly, in one embodiment, the hydrogel does not comprise a separate support structure, such as a separate porous support structure. This does not preclude from the hydrogel itself being porous in nature, for example when swollen with a liquid swelling agent. Thus it will be understood that, where the hydrogel is “self-supporting”, there is no support material (e.g. scaffold) exogenous to the hydrogel.

In a related embodiment, the hydrogel particles are flowable (i.e. exhibits dry and powdery properties) allowing it to flow as a loose particulate without being overly sticky or rigid. Advantageously, the hydrogel particles remain in the form of a dry, free-flowing powder, i.e. without substantial escape of the liquid swelling agent (if present) to the outside of the particles, even when acidic gas is absorbed. Because the hydrogel particulate is typically a dry, free flowing powder, there is no bulk liquid phase present during the absorption. The free-flowing nature of the hydrogel particles may provide certain advantages, for example allows hydrogel particles to be contacted with the gaseous stream or atmosphere using a fluidized bed reactor.

In some embodiments, the hydrogel may be provided as layer within a column, wherein the gaseous stream or atmosphere is flowed through the column and passes through the hydrogel layer. The layer is not limited to any particular hydrogel morphology. In one example, a suitable column may be packed with a plurality of hydrogel particles to form a packed-bed with sufficient interstitial space between adjacent particles to allow a flow of gas therethrough. Alternatively, the hydrogel may be provided in flow with the gaseous stream (e.g. a fluidised bed reactor).

In some embodiments or examples, the hydrogel may be provided as a coating composition on a substrate. In some embodiments or examples, the substrate may be planar, for example a planar sheet. In a particular example, the substrate may be a flexible sheet. A planar substrate provides a two sided element onto which the hydrogel coating composition can be applied. Each substrate may be coated with the hydrogel coating composition on two opposing sides. The planar substrate can have any configuration. In some embodiments or examples, the planar substrate may comprise a flat solid surface. In other embodiments or examples, the planar substrate may comprise one or more apertures, designed to assist gas flow through and around the substrate. In a particular embodiment or example, the substrate may comprise a mesh, for example, micro wire mesh. The use of a mesh provides a multitude of apertures, (e.g. micro size apertures), thereby providing a high surface area on which the hydrogel coating composition can be applied, whilst also providing a suitable flow path having a reasonably low pressure drop across the substrate (relative to the size and configuration of the mesh) compared to other configurations, for example, packed beds. The hydrogel may be ground/crushed into a plurality of particles.

### Liquid Swelling Agent

Hydrogels are capable of absorbing and retaining large amounts of a liquid swelling agent (such as water or a non-aqueous solvent) relative to its mass. In some embodiments, the hydrogel is capable of absorbing at least 5 times its own weight in fluid up to 300 times its own weight in fluid. The surface area within the hydrogel may be increased depending on the degree of swelling of the hydrogel. For example, the hydrogel may comprising a liquid swelling agent (such as water or an alkanolamine) which swells the hydrophilic polymer network of the hydrogels into a more open mobile structure with liquid-filled pores which may increase the accessibility of acidic gases (e.g. CO₂ or H₂S) to the reactive functional groups on the hydrophilic polymer and/or on the liquid swelling agent. Hydrogels also have has a swelling capacity (sometimes referred to as the maximum swelling capacity), which essentially defines the swelling limit of the hydrogel.

As discussed above, the hydrogel may have a swelling capacity (i.e. is capable of absorbing liquid) The typical method to determine this is by taking a known weight of the dry hydrogel and swelling in an excess of liquid for a specified period of time (typically 48 hours). After which time the excess liquid is removed by filtration and the hydrogel weight is recorded to determine the swelling ratio. By way of example, to determine the swelling capacity of a hydrogel, a known mass (g) of a dry hydrogel is dispersed in a liquid swelling agent (such as water) for 48 hours at room temperature, after which any non-absorbed free liquid is removed, and the swollen hydrogel is weighed. The mass difference between the dry and swollen state of the hydrogel corresponds to the amount of the absorbed liquid, which is then calculated as a grams of liquid per gram of hydrogel (g/g).

In some embodiments, the hydrogel may have swelling capacity of at least about 1, 5, 10, 20, 30, 40, 50, 60, 70, 80, 90, 100, 150, or 200 g/g. In other embodiments, the hydrogel may have a swelling capacity of less than about 200, 150, 100, 90, 80, 70, 60, 50, 40, 30, 20, 10, 5 or 1 g/g. Combinations of these swelling capacity values to form various ranges are also possible, for example the hydrogel may have a swelling capacity of between about 20 g/g to about 100 g/g. The swelling capacity can also be provided as a percentage, for example a swelling capacity of 0.5 g/g equates to 50% (i.e. the hydrogel swells 50%).

The swelling capacity of the hydrogel can also vary depending on the liquid swelling agent. For example, the hydrogel may have a different swelling capacity with water as the liquid swelling agent compared to glycerol as the liquid swelling agent. For example, the hydrogel may have a swelling capacity of between about 1 g/g to about 200 g/g, for example between about 20 g/g to about 200 g/g water. In some embodiments, the hydrogel may have swelling capacity of at least about 1, 5, 10, 20, 30, 40, 50, 60, 70, 80, 90, 100, 150, or 200 g/g water. In other embodiments, the hydrogel may have a swelling capacity of less than about 200, 150, 100, 90, 80, 70, 60, 50, 40, 30, 20, 10, 5 or 1 g/g water. Combinations of these swelling capacity values to form various ranges are also possible, for example the hydrogel may have a swelling capacity of between about 20 g/g to about 100 g/g water.

In another example, the hydrogel may have a swelling capacity of between about 1 g/g to about 200 g/g, for example between about 20 g/g to about 200 g/g glycerol. In some embodiments, the hydrogel may have swelling capacity of at least about 0.5, 1, 5, 10, 20, 30, 40, 50, 60, 70, 80, 90, 100, 150, or 200 g/g glycerol. In other embodiments, the hydrogel may have a swelling capacity of less than about 200, 150, 100, 90, 80, 70, 60, 50, 40, 30, 20, 10, 5 1, or 0.5 g/g glycerol. Combinations of these swelling capacity values to form various ranges are also possible, for example the hydrogel may have a swelling capacity of between about 1 g/g to about 200 g/g, or between about 20 g/g to about 100 g/g glycerol. The swelling capacity can also be provided as a percentage, for example a swelling capacity of 0.5 g/g equates to 50% (i.e. the hydrogel swells 50%).

In some embodiments, the hydrogel is swollen with a liquid swelling agent to between about 60% to about 99% of the hydrogels swelling capacity. For example, the hydrogel may be swollen to at least about 60, 70, 80, 90, 95, 98, or 99% of the hydrogels swelling capacity. The hydrogel may be swollen to less than about 99, 98, 95, 90, 80, 70, or 60% of the hydrogels swelling capacity. Combinations of these % values to form various ranges are also possible, for example the hydrogel may be swollen to between about 70% to about 98% of the hydrogels swelling capacity, for example between about 80% to about 95% of the hydrogels swelling capacity.

In one embodiment, the amount of liquid swelling agent absorbed within the hydrogel does not exceed the swelling capacity of the hydrogel. According to some embodiments or examples, by not exceeding and/or operating below the hydrogels swelling capacity, the hydrogel exhibits “dry” and “powdery” characteristics and when in particulate form is capable of flowing, even with the presence of liquid swelling agent absorbed therein. By ensuring that the amount of absorbed liquid, and any moisture from the gaseous stream that may also be absorbed when in use, is at or near the hydrogel swelling capacity whilst not exceeding the same, the amount of liquid within each particle can be maximised to allow for increased acidic gas absorption, whilst retaining the hydrogel's “dry” and “powdery” characteristics.

The hydrogel is capable of swelling and retaining the absorbed liquid swelling agent within the hydrogel. The hydrogel may be capable of swelling and retaining about 0.5 wt. % to about 99 wt. % liquid swelling agent based on the total weight of the hydrogel (e.g. the weight of the hydrogel and any liquid swelling agent absorbed therein). The liquid swelling agent may be strongly or weakly bound to the cross-linked hydrophilic polymer network within the hydrogel or may be non-bound. The amount of liquid swelling agent in the hydrogel can vary depending on the degree of swelling or dehydration of the hydrogel. For example, the hydrogel may comprise between 0.5 wt. % to about 99 wt. % liquid swelling agent based on the total weight of the hydrogel.

In some embodiments, the hydrogel may comprise at least about 0.5, 1, 5, 10, 20, 30, 40, 50, 60, 70, 80, 90, or 99 wt. % liquid swelling agent based on the total weight of the hydrogel. In some embodiments, the hydrogel may comprise less than about 99, 90, 80, 70, 60, 50, 40, 30, 20, 10, 5, 1, or 0.5 wt. % liquid swelling agent based on the total weight of the hydrogel. Combinations of these wt. % values to form various ranges are also possible, for example the hydrogel may comprise between about 30 wt. % to about 99 wt. % liquid swelling agent, for example between about 40 wt. % to about 99 wt. % liquid swelling agent based on the total weight of the hydrogel.

In some embodiments, the hydrogel comprises between about 50 wt. % to about 99 wt. % liquid swelling agent based on the total weight of the hydrogel. In some embodiments, the hydrogel comprises at least about 50, 55, 60, 65, 70, 75, 80, 85, 90, 95, or 99 wt. % liquid swelling agent based on the total weight of the hydrogel. In other embodiments, the hydrogel comprises less than about 99, 95, 90, 85, 80, 75, 70, 65, 60, 55, or 55 wt. % liquid swelling agent based on the total weight of the hydrogel t. Combinations of these wt. % values to form various ranges are also possible, for example the hydrogel comprises between about 85 wt. % to about 98 wt. % liquid swelling agent based on the total weight of the hydrogel. Suitable liquid swelling agents are described herein.

In some embodiments, the weight ratio % of absorbed liquid swelling agent to hydrogel may be at least about 1:5, 1:4, 1:3, 1:2, 1:1, 1.5:1, 2:1, 2:5:1, 3:1, 3.5:1, 4:1, 4.5:1 or 5:1. In some embodiments, the weight ratio % of absorbed liquid swelling agent to hydrogel may be less than about 5:1, 4.5:1, 4:1, 3.5:1, 3:1, 2.5:1, 2:1, 1.5:1, 1:1, 1:2, 1:3, 1:4 or 1:5. The weight ratio % of absorbed liquid swelling agent to hydrogel may be a range provided by any two of these upper and/or lower values, for example the between about 1:1 to about 5:1. According to some embodiments or examples, this ratio may provide one or more advantages, including maximising the amount of reactive functional groups for capture of the acidic gas (e.g. swells the hydrophilic polymer network of the hydrogels into a more open mobile structure with liquid-filled pores which may increase the accessibility of acidic gases (e.g. CO₂ or H₂S) to the reactive functional groups on the hydrophilic polymer and/or on the liquid swelling agent) whilst maintaining the powdery “dry” characteristics of the hydrogel, which when in particulate form allows them to flow for example in a fluidised bed reactor.

Alternatively, the hydrogel may be in a dry or dehydrated state where some of the absorbed liquid swelling agent is removed or evaporated. A dry hydrogel (also known as a dehydrated hydrogel) may comprise about 0.01% to about 20% liquid swelling agent based on the total weight of the hydrogel, for example between about 0.5 wt. % to about 10 wt. % liquid swelling agent based on the total weight of the hydrogel.

In one embodiment, the liquid swelling agent is a non-polymeric liquid with a molecular weight of below 500 g/mol. It is challenging to load high amounts of polymeric liquid swelling agent into a hydrogel because such materials are either solids or high viscosity liquids. Moreover, the diffusion of acidic gases into the hydrogel composition limits CO₂ absorption capacity even at relatively low loadings of a polymeric liquid swelling agents. In some embodiments, therefore, the molecular weight of the liquid swelling agent is less than 500 g/mol, preferably less than 200 g/mol.

The liquid swelling agent may have low volatility. For example, the liquid swelling agent may have a boiling point of at least about 100, 120, 140, 160, 200, 220, 240, 260, 280, or 300° C. The liquid swelling agent may have a boiling point of less than about 300, 280, 260, 240, 220, 200, 160, 140, 120, or 100° C. Combinations of these boiling points to provide various ranges are also possible, for example the liquid swelling agent has a boiling point of between about 100° C. to about 300° C. The boiling point of the liquid swelling agent can vary depending on the liquid swelling agent, for example water has a boiling point of about 100° C., glycerol has a boiling point of about 290° C., and monoethylene glycol (MEG) has a boiling point of about 198° C. According to at least some embodiments or examples described herein, high boiling point solvents may result in lower evaporation loss of the solvent when the hydrogel comprising the solved as a liquid swelling agent is subjected to regeneration (e.g. heating with steam) to remove captured acidic gases (e.g. CO₂ or H₂S), resulting in the acidic gas being selectively removed before the solvent evaporates.

The liquid swelling agent may be water, a non-aqueous solvent, or a combination thereof. In one embodiment, the liquid swelling agent is a non-aqueous solvent. The non-aqueous solvent may be a polar solvent. In one embodiment, the liquid swelling agent may comprise one or more functional groups capable of binding to an acidic gas (e.g. CO₂ or H₂S), for example an amine. Alternatively or additionally, the liquid swelling agent may comprise a group that can help to dissolve the acidic gases (e.g. CO₂ or H₂S), for example hydroxyl groups.

In one embodiment, at least one acidic gas absorbent is incorporated within the hydrogel as part of a liquid swelling agent absorbed within the hydrogel. For example, the liquid swelling agent comprises an acidic gas absorbent for incorporating at least one acidic gas absorbent within the hydrogel. In one embodiment, the liquid swelling agent comprises one or more functional groups capable of binding to the acidic gas by a chemical process or is a liquid capable of absorbing acidic gas by a physical process.

In one embodiment, the liquid swelling agent comprises one or more functional groups capable of binding to the acidic gas by a chemical process, for example by binding to the acidic gas via one or more functional groups (e.g. amines) present in the liquid swelling agent. The term “by a chemical process” means the preferential absorption of the liquid swelling agent to an acidic gas within a gaseous stream or atmosphere by means of a chemical reaction wherein a charge is transferred, for example by binding to the acidic gas via one or more functional groups (e.g. amines) present in liquid swelling agent. Suitable liquids that are capable of absorbing the acid gas by a chemical process include, but are not limited to, amines including alkanolamines, alkylamines, and alkyloxyamines, piperidine and its derivatives, piperazine and its derivatives, pyridine and its derivatives, and mixtures thereof, as described herein.

Examples of suitable amines include primary amines such as monoethanolamine, ethylenediamine, 2-amino-2-methylpropanol, 2-amino-2-methyl-ethanolamine and benzylamine; secondary amines such as N-methylethanolamine, piperazine, piperidine and substituted piperidine, N-alkyl derivatives of 2-amino-1-propanol (AP), especially 2-N-methylamino-1-propanol (MAP), 2-N-methylamino-2-methyl-1-propanol (MAMP), as well as derivatives with two or more hydroxyl groups and/or ether derivatives, diethanolamine, diglycolamine and diisopropanolamine; and tertiary amines such as N-methyldiethanolamine, and amino acids such as taurine, sarcosine, alanine, 2-amino-2-methyl-1-propanol (AMP), 3-piperidinemethanol, 3-piperidineethanol, 2-piperidinemethanol, 2-piperidineethanol, N-piperidinemethanol, N-piperidineethanol, 2-methylaminoethanol, N,N-dimethylaminoethanol and 3-quinuclidinol. monoethanolamine, diethanolamine, aminoethylethanolamine, diglycolamine, piperazine, N-aminoethylpiperazine, N-(2-hydroxyethyl)piperazine and morpholine.

The liquid swelling agent may be selected from the group consisting of water, alcohols, polyol compounds, glycols, amines (e.g. alkanolamines, alkylamines, alkyloxyamines), piperidines, piperazines, pyridines, pyrrolidones, and derivatives or combinations thereof. Suitable alkanolamines may include monoethanolamine, diethanolamine, methyldiethanolamine, diisopropanolamine, N-ethylmonoethanolamine and aminoethoxyethanol. Suitable alkylamines may include an ethyleneamine, for example tetraethylpentamine (TEPA). Suitable glycols may include ethylene glycol, monoethylene glycol, diethylene glycol, triethylene glycol, propylene glycol, propanediol, butylene glycol, Triethylene glycol, polyethylene glycol, and diglyme. Suitable alcohols may include 2-ethyoxyethanol, 2-methoxyethanol. Suitable polyol compounds may include glycerol. Suitable piperidines include piperidine, 2-methylpiperidine, 3-methylpiperidine, 4-methylpiperidine, 2-piperidineethanol (PE), 3-piperidinemthanol, and 4-piperidinemthanol. The liquid swelling agent may comprise any one or more of the above liquids. In one embodiment, the liquid swelling agent is selected from the group consisting of alkylamines, alkanolamines, and glycols, and combinations thereof.

In some embodiments, the liquid swelling agent may be selected from the group consisting of water, monoethanolamine, diethanolamine, methyldiethanolamine, diisopropanolamine, N-ethylmonoethanolamine, aminoethoxyethanol, ethylene glycol, Triethylene glycol, monoethylene glycol, diethylene glycol, triethylene glycol, propylene glycol, propanediol, butylene glycol, polyethylene glycol, glycerol, diglyme, 2-ethyoxyethanol, 2-methoxyethanol, glycerol, 2-methylpiperidine, 3-methylpiperidine, 4-methylpiperidine, 2-piperidineethanol (PE), 3-piperidinemthanol, and 4-piperidinemthanol.

In one embodiment, the liquid swelling agent is a liquid capable of absorbing acidic gas by a physical process. The term “by a physical process” means the absorption of the acidic gas from a gaseous stream or atmosphere by physical characteristics and not by means of a chemical reaction (e.g. the liquid swelling agent does not chemically bind to the acidic gas but can dissolve it). Suitable liquids capable of absorbing acidic gases (e.g. CO₂ or H₂S) by a physical process (e.g. do not chemically bind to the acidic gas but can dissolve it) include but are not limited to polyethylene glycols, alkyl ethers of polyethylene glycols and in particular dialkyl ethers such as dimethyl ethers of polyethylene glycol, N-methylpyrrolidone, propylene carbonate, methanol, sulfolane (tetrahydrothiophenedioxide), estasolvan (tributyl phosphate), imidazoles, ionic liquids, primary amines, secondary amines, tertiary amines, sterically hindered amines, and mixtures thereof. Specific examples of commercially available physical solvents include dimethyl ether (DEPG) of polyethylene glycol (UOP LLC; Des Plaines, IL) used in the SELEXOL process; methanol used in the RECTISOL® process (Lurgi AG; Frankfurt, Germany); RECTISOL® n-methyl-2-pyrrolidone (NMP) (Lurgi AG); and propylene carbonate (PC) used in the FLUOR SOLVENT process (Fluor Corp).

In one embodiment, the liquid swelling agent is selected from the group consisting of water, monoethylene glycol, polyethyleneglycol, glycerol, 2-methoxyethanol, 2-ethoxyethanol, monoethanolamine, diethanolamine, methyldiethanolamine, diisopropanolamine, and aminoethoxyethanol, and combinations thereof. In one embodiment, the liquid swelling agent is water, glycerol, monoethanolamine, diethanolamine, 2-piperidineethanol, ethylene glycol, Triethylene glycol, or monoethyleneglycol (MEG) or combinations thereof.

In some embodiments, the liquid swelling agent is capable of absorbing acidic gases (e.g. CO₂ or H₂S) when contacted with a gaseous stream or atmosphere. Suitable liquid swelling agents that are capable of absorbing acidic gases (e.g. CO₂ or H₂S) include one or more of the liquid swelling agents described herein. In some embodiments, the liquid swelling agent may absorb acidic gases (e.g. CO₂ or H₂S) by a chemical or physical process. In some embodiments, the liquid swelling agent comprises functional groups capable of binding to acidic gases (e.g. CO₂ or H₂S). For example, the liquid swelling agent may comprise one or more amine groups, such as a primary amine (—NH₂) or secondary amine group (—NH—). Such amine groups are H₂S and CO₂-phillic and readily react and bind with H₂S and CO₂. In some embodiments, the liquid swelling agent comprises one or more amine groups amine, such as an alkanolamine. In another example, the liquid swelling agent comprises two or more (—OH) groups which are capable of physically dissolving acidic gases (e.g. CO₂ or H₂S), for example a glycol, a polyol or dimethyl ethers as described herein.

In some embodiments, the hydrogel may comprise at least about 0.5, 1, 5, 10, 20, 30, 40, 50, 60, 70, 80, 90, or 99 wt. % water. In some embodiments, the hydrogel may comprise less than about 99, 90, 80, 70, 60, 50, 40, 30, 20, 10, 5, 1, or 0.5 wt. % water. Combinations of these wt. % values to form various ranges are also possible, for example the hydrogel may comprise between about 40 wt. % to about 99 wt. % water. The water may have a degree of salinity, e.g. may be a brine or salt water.

In some embodiments, the hydrogel may comprise at least about 0.5, 1, 5, 10, 20, 30, 40, 50, 60, 70, 80, 90, or 99 wt. % glycerol. In some embodiments, the hydrogel may comprise less than about 99, 90, 80, 70, 60, 50, 40, 30, 20, 10, 5, 1, or 0.5 wt. % glycerol. Combinations of these wt. % values to form various ranges are also possible, for example the hydrogel may comprise between about 40 wt. % to about 99 wt. % glycerol.

In some embodiments, the hydrogel may comprise at least about 0.5, 1, 5, 10, 20, 30, 40, 50, 60, 70, 80, 90, or 99 wt. % monoethyleneglycol (MEG). In some embodiments, the hydrogel may comprise less than about 99, 90, 80, 70, 60, 50, 40, 30, 20, 10, 5, 1, or 0.5 wt. % monoethyleneglycol (MEG). Combinations of these wt. % values to form various ranges are also possible, for example the hydrogel may comprise between about 40 wt. % to about 99 wt. % monoethyleneglycol (MEG).

In some embodiments, the hydrogel may comprise at least about 0.5, 1, 5, 10, 20, 30, 40, 50, 60, 70, 80, 90, or 99 wt. % of an alkanolamine. In some embodiments, the hydrogel may comprise less than about 99, 90, 80, 70, 60, 50, 40, 30, 20, 10, 5, 1, or 0.5 wt. % of an alkanolamine. Combinations of these wt. % values to form various ranges are also possible, for example the hydrogel may comprise between about 40 wt. % to about 99 wt. % of an alkanolamine. Suitable alkanolamines are described herein.

In some embodiments, the hydrogel may comprise at least about 0.5, 1, 5, 10, 20, 30, 40, 50, 60, 70, 80, 90, or 99 wt. % of a glycol. In some embodiments, the hydrogel may comprise less than about 99, 90, 80, 70, 60, 50, 40, 30, 20, 10, 5, 1, or 0.5 wt. % of a glycol. Combinations of these wt. % values to form various ranges are also possible, for example the hydrogel may comprise between about 40 wt. % to about 99 wt. % of a glycol. Suitable glycols are described herein.

In some embodiments, the hydrogel may comprise at least about 0.5, 1, 5, 10, 20, 30, 40, 50, 60, 70, 80, 90, or 99 wt. % a piperidine. In some embodiments, the hydrogel may comprise less than about 99, 90, 80, 70, 60, 50, 40, 30, 20, 10, 5, 1, or 0.5 wt. % a piperidine. Combinations of these wt. % values to form various ranges are also possible, for example the hydrogel may comprise between about 40 wt. % to about 99 wt. % a piperidine. Suitable piperidines are described herein.

The liquid swelling agent may further comprise an amino acid salt. The incorporation of an amino acid salt within the liquid swelling agent can improve acidic gas absorption. Due to the presence of the amino functional group, CO₂ can bind with the amino acid salt thus increasing CO₂ absorption. The amino acid salt may comprise any suitable amino acid or derivative thereof, for example glycine, proline, sarcosine, or taurine. The amino acid salt may comprise any suitable salt, including ammonium salts, alkali metal salts, for example those of potassium and sodium, alkaline earth metal salts, for example those of calcium and magnesium. The amino acid salt may be potassium glycinate, potassium sarcosinate, potassium proline, or isopropyl glycinate. In one embodiment, the amino acid salt is potassium sarcosinate.

The liquid swelling agent may also increase the thermal conductivity of the hydrogel. The one or more advantages of increasing the thermal conductivity of the hydrogel are described herein.

The hydrogel may further comprise a chelator (i.e. a chelating agent). The chelator can improve the stability of the hydrogel by chelating to any residual metal that may be present within the hydrophilic polymer, for example one or more contaminants such as lead or copper. The chelator may be a phosphate salt, for example potassium phosphate or sodium phosphate. In one embodiment, the chelator is sodium phosphate. Other suitable chelators can include EDTA, deferoxamine mesylate salt, chromium picolinate, zinc picolinate and pentetic acid.

The absorptive capacity of the hydrogel may be enhanced by incorporating a hygroscopic salt into the hydrogel, either as part of the cross-linked hydrophilic polymer and/or as part of the liquid swelling agent, or as a separate aqueous solution that is absorbed into the hydrogel. The hygroscopic salt may be a monovalent salt such as lithium chloride, lithium bromide or sodium chloride, or a divalent salt such as calcium chloride, calcium sulphate. The hygroscopic salt may be present in the cross-linked polymer network in any amount up to saturation thereof.

Where a hydrogel comprises a non-aqueous solvent liquid swelling agent, the hydrogel may be prepared using the non-aqueous solvent as the dispersion medium (e.g. the hydrophilic polymer is dispersed in the non-aqueous liquid swelling agent, and cross-linked therein to form the hydrogel). Alternatively, the hydrogel may be prepared using water as the dispersion medium, and is subsequently dried/dehydrated to remove the absorbed water, and then the non-aqueous solvent is added to the hydrogel and absorbed therein. For example, the dried hydrogel may be immersed in the non-aqueous solvent, and left for a period of time to infuse/absorb the non-aqueous solvent. Alternatively, the hydrogel may be a commercially available hydrogel (e.g. Bio-Gel® P polyacrylamide beads) which are subsequently added to the liquid swelling agent to be absorbed therein.

### Thermally Conductive Particulate Material

The hydrogel comprises a thermally conductive particulate material. The thermally conductive particulate material may be interspersed on or within the hydrogel. For example, the thermally conductive particulate material may be interspersed within the cross-linked hydrophilic polymer forming the hydrogel. Alternatively or additionally, the thermally conductive particulate material may be interspersed on or within the surface of the hydrogel.

In some embodiments, the interspersed thermally conductive particulate material on or within the hydrogel may be provided by at least one of:
a) thermally conductive particulate material intercalated, interspersed or embedded within the hydrogel;
b) intercalated, interspersed or embedded into the surface of the hydrogel; and
c) an additional coating on the surface of the hydrogel.

In some embodiments, the thermally conductive particulate material is not chemically grafted to the cross-linked hydrophilic polymer of the hydrogel (i.e. there is no chemical bonding between the hydrophilic polymer matrix and the thermally conductive particulate material).

In one embodiment, the thermally conductive particulate material is not chemically grafted to the one or more reactive functional groups on the cross-linked hydrophilic polymer of the hydrogel. For example, where the hydrogel comprises a cross-linked polyamine (such as a cross-linked polyethylenimine), in some embodiments the thermally conductive particulate material is not chemically grafted to one or more amine groups on the cross-linked polyethylenimine. According to some embodiments or examples, the lack of chemical grafting may arise in part due to the thermally conductive particulate material being chemically inert. For example, graphite is chemically inert and lacks reactive groups capable of chemically grafting to one or more functional groups, such as amines, on the cross-linked hydrophilic polymer. In contrast, graphene oxide comprising reactive epoxide and carboxylic acid groups capable of reacting with amine groups. Such chemical grafting to free amine groups is expected may reduce the acidic gas absorption capacity of the hydrogels due reducing the number of reactive amine groups available to bind and capture acidic gas (such as CO₂ or H₂S).

In a related embodiment, the thermally conductive particulate material is chemically inert, in that it lacks reactive groups capable of chemically grafting to one or more functional groups, such as amines. In another related embodiment, the thermally conductive particulate material is not chemically grafted to an acidic gas absorbent (which is can be incorporated within the hydrogel as one or more reactive functional groups (e.g. amines) on the cross-linked hydrophilic polymer for binding to the acidic gas and/or as part of a liquid swelling agent absorbed within the hydrogel. According to some embodiments or examples described herein, by not chemically grafting the thermally conductive particulate material to the cross-linked polymer/acidic gas absorbent, improved acidic gas absorption performance may be obtained.

In one embodiment, the thermally conductive particulate material is provided as a neat material (i.e. a pure substance, including for example a single compound, or a single element, which has not been functionalised or cross-linked with an exogenous material). In another embodiment, the thermally conductive particulate material does not comprise graphene oxide.

It will be appreciated that the interspersion of the thermally conductive particulate material on or within the hydrogel can be determined by a range of instruments and methods including spectroscopy and microscopy methods, for example scanning electron microscopy.

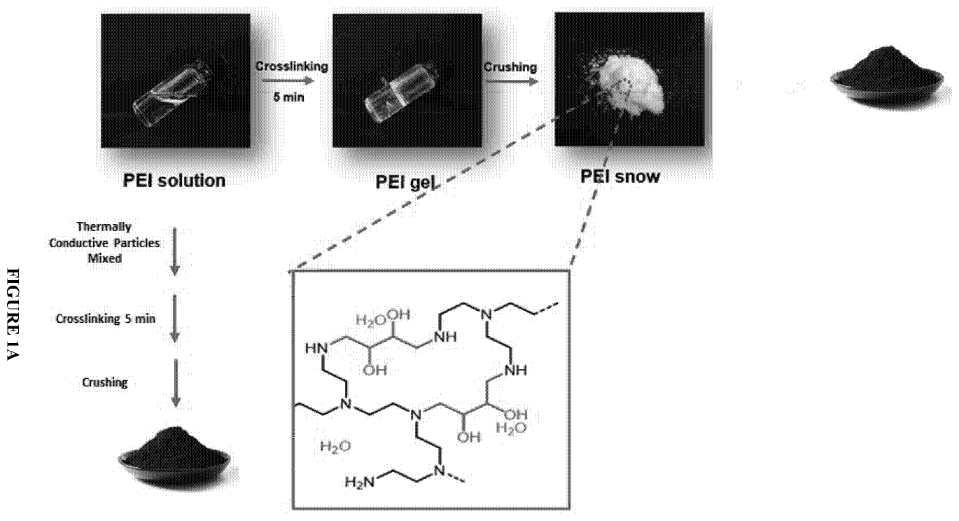

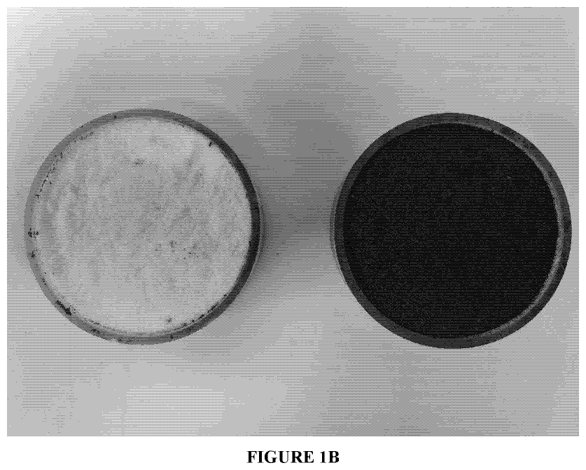

The thermal conductivity of a material is a measure of its ability to conduct heat. Heat transfer occurs at a lower rate in materials of low thermal conductivity than in materials of high thermal conductivity. As used herein, the term “thermally conductive particulate material” refers to a particulate material having a thermal conductivity capable of conducting and transferring heat throughout the hydrogel when heated at a faster rate compared to a hydrogel comprising no particulate material. Such thermal conductivity properties can aid in the regeneration to remove captured acidic gases, for example at lower temperatures. The particulate material may be homogenously dispersed on or within the hydrogel. For example, the particulate material may be uniformly dispersed throughout the cross-linked hydrophilic polymer and/or may be uniformly dispersed on the surface of the hydrogel. This can be achieved by adding the thermally conductive particles during the synthesis (e.g. in-situ) or after the polymer is formed by blending with the crosslinked polymer with the thermally conductive particles (e.g. ex-situ) (FIG. 1).

The thermal conductivity of the particulate material can be measured by any suitable technique, for example according to ASTM E1225. To measure the thermal conductivity, the hydrogel comprising the particulate material may be dissolved to separate and obtain the particulate material (e.g. via centrifugation) which can then undergo thermal conductivity measurements. Alternatively or additionally, the particulate material may have its thermal conductivity measured prior to incorporation into the hydrogel.

The thermally conductive particulate material may have a bulk thermal conductivity. The bulk thermal conductivity of the particulate material is independent of the particulate materials particle size, as understood by the person skilled in the art.

The thermally conductive particulate material may have a bulk thermal conductivity (in W/(m/K) at 25° C.) of between about 20 to about 2000. The particulate material may have a bulk thermal conductivity (in W/(m/K) at 25° C.) of at least about 20, 25, 50, 100, 150, 200, 250, 300, 500, 700, 1000, 1200, 1500, 1700 or 2000. The particulate material may have a bulk thermal conductivity (in W/(m/K) at 25° C.) of less than about 2000, 1700, 1500, 1200, 1000, 700, 500, 300, 250, 200, 150, 100, 50, 25 or 20. The bulk thermal conductivity be in a range provided by any two of these upper and/or lower values, for example between about 20 to about 1000, about 20 to about 500, about 100 to about 500, or about 100 to about 200 W/(m/K) at 25° C.

It will be appreciated that the hydrogel comprising the thermally conductive particulate material interspersed may also have a thermal conductivity (also referred to as an apparent thermal conductivity owing to the heterogeneous nature of the hydrogel, e.g. comprising both hydrogel and particulate material). The thermal conductivity of the hydrogel may be lower than that of the particulate material itself, but according to some examples described herein, is greater than the thermal conductivity of the same hydrogel that does not comprise any thermally conductive particulate materials. The hydrogel comprising the particulate material described herein may be measured to determine its thermal conductivity, for example using test methods outlined in ASTM E1225 or ASTM D5470. In one embodiment, the thermal conductivity of the hydrogel is measured using the test method outlined in ASTM D5470.

In some embodiments, the hydrogel comprising the thermally conductive particulate material has a thermal conductivity of between about 0.1 to 2000 W/(m/K) at 25° C. In one embodiment, the thermal conductivity of the hydrogel can be increased at least a factor of 2, 3, 4, 5, 6, 7, 8, 9 or 10 following interspersion of the thermally conductive particulate material on or within the hydrogel. For example, the thermal conductivity of a hydrogel alone may be less than about 0.1 W/(m/K) whereas a hydrogel comprising thermally conductive particulate material interspersed on or within the hydrogel may have a thermal conductivity of greater than 0.1 W(m/K).

According to at least some embodiments or examples described herein, the present inventors have surprisingly found that by incorporating various types of carbon-based particulate materials (e.g. graphite, carbon black) within the hydrogel, the effective thermal conductivity can be improved, whilst maintain good regeneration. Additionally, swelling the hydrogel with a liquid swelling agent described herein can also improve the hydrogels thermal conductivity.

The thermally conductive particulate material may be provided in an amount effective to conduct and transfer heat throughout the hydrogel when the hydrogel is heated. In some embodiments, the hydrogel comprises about 10% w/w to about 80% w/w of the particulate material based on the total weight of the hydrogel. In some embodiments, the hydrogel may comprise at least about 10, 20, 30, 40, 50, 60, 70, or 80% w/w of the particulate material based on the total weight of the hydrogel. In some embodiments, the hydrogel may comprise less than about 80, 70, 60, 50, 40, 30, 20 or 10% w/w of the particulate material based on the total weight of the hydrogel. The hydrogel may comprise particulate material in a range provided by any two of these upper and/or lower values, for example between about 20% w/w to about 70% w/w, or about 30% w/w/ about 50% w/w of the particulate material based on the total weight of the hydrogel.

In one embodiment, the hydrogel may be a dry or dehydrated hydrogel. In this embodiment, the dry or dehydrated hydrogel may comprise between about 30 wt. % to about 80 wt. % of particulate material based on the total weight of the dehydrated hydrogel. The dry or dehydrated hydrogel may comprise at least about 30, 35, 40, 45, 50, 55, 60, 65, 70, 75 or 80 wt. % of particulate material based on the total weight of the dehydrated hydrogel. The dry or dehydrated hydrogel may comprise less than about 80, 75, 70, 65, 60, 55, 50, 45, 40, 35, or 30 wt. % of particulate material based on the total weight of the dehydrated hydrogel. The dry or dehydrated hydrogel may comprise particulate material in a range provided by any two of these upper and/or lower values.

The particulate material may be any suitable material that has a thermal conductivity effective to conduct and transfer heat throughout the hydrogel when the hydrogel is heated. In some embodiments, the thermally conductive particulate material is selected from one or more of a carbon based material, a conducting polymer, a metal or metal alloy, or a metalloid or a salt thereof.

In some embodiments, the carbon based material may be selected from the group consisting of graphite, carbon black, carbon nanotubes, or carbon fibres. In one embodiment, the thermally conductive particulate material is graphite. Any suitable graphite may be used, for example crystalline, semi-crystalline, pyrolytic, flake and/or amorphous graphite. In one embodiment, the thermally conductive particulate material is amorphous graphite. The graphite may have a bulk thermal conductivity (in W/(m/K) between about 20 to 500 at 25° C., for example, between about 100 to about 200.

In one embodiment, the thermally conductive particulate material may be exfoliated prior to interspersion on or within the hydrogel. For example, graphite may be exfoliated which may promote good contact between the hydrophilic polymer and the graphite.

In some embodiments, the conducting polymer may be selected from polyfluorene, polyphentlene, polypyrene, polyazulene, polynaphtalene, polypyrrole, polycarbzole, polyundole, polyazepine, polyaniline, polythiophene, poly(3,4-ethylenediaoxythiophene, poly(p-phenyylene sulfide), polyacetylene or poly(p-phenylene vinylene), and copolymers thereof. The conducting polymer may be prepared by conventional methods, and in some embodiments micronized to form a particulate conducting polymer. In one embodiment, the thermally conductive particulate material is polyaniline, polythiophene or polypyrrole, or copolymers thereof.

In some embodiments, the thermally conductive particulate material may be a metal selected from one or more of silver, copper, iron, gold, aluminium, magnesium, lithium, molybdenum, nickel, palladium, platinum, rhodium, boron, cadmium, beryllium, carbon, tungsten, and zinc, or metal oxides or metal alloys comprising one or more metals described herein. The metal alloy may be selected from one or more of brass, steel, or bronze. The metal oxide may be zinc oxide alumina or copper oxide. The metalloid may be boron nitride or aluminium nitride.

The thermally conductive particulate material may be any morphology, for example may take the form of flakes, fibres, agglomerates, granules, powders, spheres, pulverized materials or the like, as well as combinations thereof. The thermally conductive particulate material may have any desired shape including, but not limited to, cubic, rod like, polyhedral, spherical or semi-spherical, rounded or semi-rounded, angular, irregular, and so forth. In one embodiment, the thermally conductive particulate material has an aspect ratio (i.e. the ratio of a length to a width, where the length and width are measured perpendicular to one another, and the length refers to the longest linearly measured dimension) of 1.0 to 10.0, 1.0 to 5.0, or 1.0 to 2.0. In one embodiment, the thermally conductive particulate material may have an aspect ratio of about 1.0 to 2.0, for example about 1.0, 1.1, 1.2, 1.3, 1.4, 1.5, 1.6, 1.7, 1.8, 1.9, or 2.0.

The thermally conductive particulate material may have a particle size which allows the thermally conductive particulate material to be interspersed on or within the hydrogel. For example, particulates of thermally conductive material may remain sufficiently suspended during preparation of the hydrogel (e.g. during cross-linking) with minimal settling resulting in a cross-linked hydrogel with thermally conductive particulate material interspersed therein. Additionally, thermally conductive material particulates have a large surface area which may result in increased thermal conductivity. Alternatively or additionally, particulates of thermally conductive material may sufficiently embed into the surface of a preformed hydrogel.

The particle size is taken to be the longest cross-sectional diameter across a thermally conductive particulate material. For non-spherical particulate materials, the particle size is taken to be the distance corresponding to the longest cross-section dimension across the particle. In some embodiments, the particulate material has an particle size of about 1 μm to about 500 μm. In some embodiments, the particulate material has an particle size of at least about 1, 2, 5, 10, 25, 50, 100, 150, 200, 250, 300, 350, 400, 450 or 500 μm. In some embodiments, the particulate material has an particle size of less than about 500, 450, 400, 350, 300, 250, 200, 150, 100, 50, 250, 10, 5, 2, or 1 μm. The particle size be in a range provided by any two of these upper and/or lower values, for example between about 10 to about 200 μm.

The particulate material may have a particle size distribution, wherein 100% of the particulates (D₁₀₀) have a particle size of less than about 500, 450, 400, 350 or 300 μm, or wherein 80% of the particulates (D₈₀) have a particle size of less than about 400, 350, 300, 250 or 200 μm, wherein 50% of the particulates (D₅₀) have a particle size of less than about 300, 250, 200, 150 or 100 μm, or wherein 20% of the hybrid electrode particulates (D₂₀) have a particle size of less than about 200, 150, 100 or 50 μm, or wherein 10% of the particulates (D₁₀) have a particle size of less than about 100, 50, 25 or 10 μm. In some embodiments, the particulates have a (D₅₀) particle size of at least about 10, 20, 50, 70, 100, 120, 150, 170, 200, 220, 250, 270 or 300 μm. In some embodiments, the particulates have a (D₅₀) particle size of less than about 300, 270, 250, 220, 200, 170, 150, 120, 100, 70, 50, 20 or 10 μm. The D₅₀ particle size distribution be in a range provided by any two of these upper and/or lower values.

The particle size and/or particle size distribution can be measured by any standard method, for example by microscopy or size exclusion methods (such mesh screens, sieves or filters) of the particulate material prior to incorporation into the hydrogel. Other methods for determining the size of the particulate material include electron microscopy (e.g. TEM, SEM, cryo-TEM or cryo-SEM) of the hydrogel comprising the particulate material, the particulate material prior to incorporation within the hydrogel and/or the particulate material obtained from the hydrogel (e.g. via dissolution and centrifugation), or dynamic light scattering of the particulate material prior to incorporation into the hydrogel. In one embodiment, the particle size and/or particle size distribution can be measured using microscopy (e.g. SEM or TEM), size exclusion methods (such as mesh screens, sieves or filters), or laser diffraction according to industry standard ISO 13320:2020, or the particulate material prior to incorporation into the hydrogel.

In some embodiments, incorporating thermally conductive particulate material having different particle sizes and/or shapes may provide good heat transfer properties.

In some embodiments, the density of particulate material in the hydrogel is about 10 to 100 particles/cm³ of hydrogel. In some embodiments, the density of particulate material in the hydrogel is at least about 10, 15, 20, 30, 40, 50, 60, 70, 80, 90 or 100 particles/cm³ of hydrogel. In some embodiments, the density of particulate material in the hydrogel is less than about 100, 90, 80, 70, 60, 50, 40, 30, 20, 15 or 10 particles/cm³ of hydrogel. The density be in a range provided by any two of these upper and/or lower values.

In some embodiments, the particulate material comprises between about 40% to about 90% of the total volume of the hydrogel. In some embodiments, the particulate material comprises at least about 40, 45, 50, 55, 60, 67, 70, 75, 80, 85 or 90% of the total volume of the hydrogel. The % volume may be in a range provided by any two of these upper and/or lower values.

### Hydrophilic Polymer

The hydrophilic polymer may also be selected to provide suitable mechanical and chemical properties to the hydrogel. For example, in some embodiments, the hydrogel may need to be able to withstand various shear and stress environments, such as when in contact with the gaseous stream and/or dry or moist/humid environments. In some embodiments, the hydrogel may also need to withstand a wide temperature range, for example when undergoing thermal regeneration. In some embodiments, the hydrogel may also need to be physically robust so that it can be introduced into various gas flowlines as a flow of particulate material or so that the particulate material can be provided in a packed bed with sufficient interstitial space between adjacent particles to allow a flow of gas (e.g. ambient air) therethrough. In some embodiments, the cross-linked hydrophilic polymer is also chemically inert. Accordingly, one or more of these properties may be provided by the appropriate selection of the hydrophilic polymer.

In some embodiments, the hydrogel comprises between about 0.05 wt. % to about 50 wt. % hydrophilic polymer based on the total weight of the hydrogel. In some embodiments, the hydrogel comprises at least about 0.01, 0.05, 0.1, 0.2, 0.5, 1, 2, 5, 10, 15, 20, 25, 30, 35, 40, 45, or 50 wt. % hydrophilic polymer based on the total weight of the hydrogel. In other embodiments, the hydrogel comprises less than about 50, 45, 40, 35, 30, 25, 20, 15, 10, 5, 2, 1, 0.5, 0.2, 0.1, 0.05 or 0.01 wt. % hydrophilic polymer based on the total weight of the hydrogel. Combinations of these hydrophilic polymer concentrations to form various ranges are also possible, for example the hydrogel comprises between about 0.01 wt. % to about 50 wt. %, about 0.05 wt. % to about 50 wt. %, about 1 wt. % to about 50 wt. %, about 0.05 wt. % to about 25 wt. %, about 10 wt. % to about 50 wt. %, about 10 wt. % to about 40 wt. %, or about 30 wt. % to about 50 wt. % hydrophilic polymer based on the total weight of the hydrogel.

In one embodiment, the hydrogel may be a dry or dehydrated hydrogel. In this embodiment, the dry or dehydrated hydrogel may comprise between about 80 wt. % to about 99.9 wt. % hydrophilic polymer based on the total weight of the dehydrated hydrogel.

In some embodiments, the hydrophilic polymer has a weight average molecular weight (M_{W}) in the range of between about 100 g/mol to about 500,000 g/mol, for example between about 1,000 g/mol to about 2,500,000 g/mol. In some embodiments, the hydrophilic polymer has a weight average molecular weight (M_{W}) of at least about 1,000, 5,000, 10,000, 50,000, 100,000, 150,000, 200,000, 250,000 or 500,000 g/mol. In other embodiments, the hydrophilic polymer has a weight average molecular weight (M_{W}) of less than about 500,000, 250,000, 200,000, 150,000, 100,000, 50,000, 10,000, 5,000 or 1,000 g/mol. Combinations of these molecular weights to form various ranges are also possible, for example the hydrophilic polymer has a weight average molecular weight (M_{W}) of between about 1,000 to about 250,000 g/mol, about 5,000 to about 50,000 g/mol, or 10,000 to about 30,000 g/mol. In some embodiments, the hydrophilic polymer has a weight average molecular weight (M_{W}) of about 25,000 g/mol. It will be appreciated that these weight average molecular weights are provided for the hydrophilic polymer prior to cross-linking. It will be appreciated that the weight average molecular weight of the hydrophilic polymer may vary depending on the type used to prepare the hydrogel. In one embodiment, the hydrophilic polymer may comprise a homopolymer or a copolymer. The weight average molecular weight can be determined using a variety of suitable techniques known to the person skilled in the art, for example gel permeation chromatography (GPC), size-exclusion chromatography (SEC) and light scattering. In one embodiment, the weight average molecular weight is determined size-exclusion chromatography (SEC).

In one embodiment, the Mw is determined using size exclusion chromatography (SEC) by passing a solution of the hydrophilic polymer through a suitable column comprising a gel that separates the hydrophilic polymer based on molecular size (i.e. hydrodynamic volumes which can be correlated with molecular weight), with larger size molecules (larger Mw) eluting first followed by smaller size molecules (smaller Mw). This can be performed in a suitable organic solvent or in aqueous media. The Mw is typically determined against a series of known polymer standards or using molar mass sensitive detectors. Suitable protocols for determining molecular weight of the hydrophilic polymer are outlined in “Size-exclusion Chromatography of Polymers” Encyclopaedia of Analytical Chemistry, 2000, pp 8008-8034, incorporated herein by reference.

In some embodiments, the hydrophilic polymer comprises a polyamine, a polyacrylamide, a polyacrylate, a polyacrylic acid, or a copolymer thereof. In some embodiments, the hydrogel comprises a cross-linked polyamine, a cross-linked polyacrylamide, or a cross-linked polyacrylate, derivative or copolymer thereof.

In some embodiments, the hydrogel comprises a cross-linked hydrophilic polymer selected from the group consisting of poly(methacrylamide), poly(dimethylacrylamide), poly(ethylacrylamide), poly(diethylacrylamide), poly(isopropylacrylamide), poly(methylmethacrylamide), poly(ethylmethacrylamide, polyacrylamide, poly(acrylamide-co-acrylic acid), poly(acrylamide-co-sodium acrylate), poly(acrylamide-co-potassium acrylate), poly(acrylamide-co-acrylic acid) partial potassium salt, poly(acrylamide-co-acrylic acid) partial sodium salt and poly (acrylamide-co-methylenebisacrylamide), polyethylenimine, polypropylenimine, polyallylamine, poly(2-hydroxyethylmethacrylate) or poly(2-hydroxyethyl acrylate), or a derivative or copolymer thereof.

In some embodiments, the hydrogel comprises a cross-linked hydrophilic polymer selected from the group consisting of polyamine, polyacrylate, polyacrylic acid, polyacrylamide or polyacrylamide-co-acrylic acid, polyacrylamide-co-acrylic acid partial sodium salt, polyacrylamide-co-acrylic acid partial potassium salt, poly(acrylic acid-co-maleic acid), poly(N-isopropylacrylamide), polyethylene glycol, polyethyleneimine, polypropylenimine, polyallylamine and vinylpyrrolidone, or a derivative or copolymer thereof. Alternatively, the hydrogel may comprise cross-linked natural hydrophilic polymers, for example polysaccharides, chitin, polypeptide, alginate or cellulose.

Other suitable cross-linked hydrophilic polymers are described herein, for example polyamines, polyacrylates, polyacrylic acids or polyacrylamides, derivatives or copolymers thereof.

The acidic gas (e.g. CO₂ or H₂S) may be removed from the gaseous stream by being absorbed into a hydrogel. For example, the acidic gas may be absorbed into the hydrogel by a chemical or physical process. In some embodiments, the cross-linked hydrophilic polymer comprise functional groups capable of binding to the acidic gas. For example, owing to its porous nature when swollen with a liquid swelling agent (which may or may not comprise an acidic gas absorbent), on contact with the hydrogel, the gaseous stream or atmosphere comprising the acidic gas can pass through the interstitial pores within the hydrogel and the acidic gas can react and bind to the functional groups on the hydrophilic polymer.

In one embodiment, at least one acidic gas absorbent is incorporated within the hydrogel as one or more functional groups capable of binding to the acidic gas on the cross-linked hydrophilic polymer. In other words, the hydrophilic polymer may comprise one or more functional groups capable of binding to the acidic gas. For example, the hydrophilic polymer may comprise one or more amine groups, such as a primary amine (—NH₂) or secondary amine group (—NH—). Such amine groups are CO₂- and H₂S-phillic and readily react and bind with CO₂ and H₂S. Thus in some embodiments, the hydrophilic polymer is a polyamine. In one embodiment, at least one acidic gas absorbent is an amine. In one example, the hydrogel may be cross-linked polyethylenimine (PEI) hydrogel, wherein the cross-linked network comprises a plurality of primary and secondary amine functional groups which are capable of reacting and binding to an acidic gas (e.g. CO₂ or H₂S) upon contact with a gaseous stream. In one embodiment, at least one acidic gas absorbent is incorporated within the hydrogel as one or more amine functional groups capable of binding to the acidic gas on the cross-linked hydrophilic polymer.

### Polyamines

In one embodiment, the hydrophilic polymer may comprise a polyamine, derivative or a copolymer thereof. As understood in the art, a polyamine is an organic compound having two or more amine groups (e.g. primary —NH₂, secondary —NHR, and/or tertiary —NR₂ amine groups).

In some embodiments, the hydrophilic polymer may comprise a liner, branched, or dendritic polyamine, derivative or copolymer thereof. A linear polyamine is defined as containing only primary amines, secondary amines, or both primary amines and secondary amines. By way of illustrative example only, the structure of one possible linear polyamine before crosslinking is provided below as Formula 1

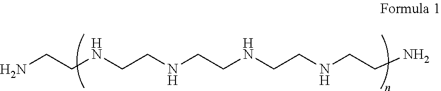

where n can be 1 to 10,000. In other examples, n may be at least 1, 10, 100, 200, 500, or 1000. In other examples, n may be less than 10,000, 9,000, 8,000, 7,000, 6,000, 5,000, 4,000, 3,000, 2,000, 1,000, 500, 200, or 100. In other examples, n may be a range provided by any two of these upper and/or lower values, for example 1 to 1000, 10 to 5,000, or 100 to 2000.

The ratio of secondary to primary amines in the linear polyamine of Formula 1 may be about 0.1 to 100. The ratio of secondary to primary amines in the linear polyamine of Formula 1 may be at least about 0.1, 0.5, 1, 2, 3, 4, 5, 6, 7, 8, 9, 10, 15, 20, 25, 30, 35, 40, 45, 50, 55, 60, 65, 70, 75, 80, 85, 90 or 95. The ratio of secondary to primary amines in the linear polyamine of Formula 1 may be less than about 100, 95, 90, 85, 80, 75, 70, 65, 60, 55, 50, 45, 40, 35, 30, 25, 20, 15, 10, 9, 8, 7, 6, 5, 4, 3, 2, 1, or 0.5. The ratio may be a range provided by any two of these upper and/or lower values.

A branched polyamine is defined as containing any number of primary (—NH₂), secondary (—NH—) and tertiary amines

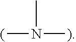

By way of illustrative example only, the structure of one possible branched polyamine before crosslinking is provided below as Formula 2 as follows:

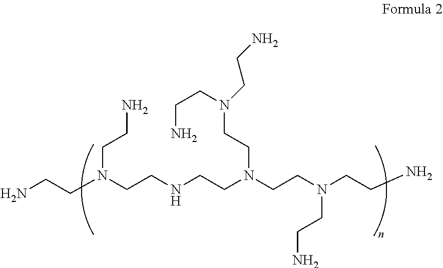

wherein n can be 1 to 10,000. In other examples, n may be at least 1, 10, 100, 200, 500, or 1000. In other examples, n may be less than 10,000, 9,000, 8,000, 7,000, 6,000, 5,000, 4,000, 3,000, 2,000, 1,000, 500, 200, or 100. In other examples, n may be a range provided by any two of these upper and/or lower values, for example 1 to 1000, 10 to 5,000, or 100 to 2000.

The ratio of primary to secondary to tertiary amine groups in the branched polyamine can be about 10:80:10 to 60:10:30, about 60:30:10 to 30:50:20, or about 45:45:10 to 35:45:20. The person skilled in the art would understand that the structures of branched polyamines can vary greatly depending on the number of tertiary amine groups present.

A dendritic polyamine is defined as containing only primary (—NH₂) and tertiary amines

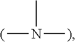

where groups of repeat units are arranged in a manner that is necessarily symmetric in at least one plane through the centre (core) of the polyamine, where each polymer branch is terminated by a primary amine, and where each branching point is a tertiary amine. The ratio of primary amine groups to tertiary amine groups in a dendritic polyamine may be about 1 to 3. By way of illustrative example only, the structure of one possible dendritic polyamine before crosslinking is provided below as Formula 3 as follows:

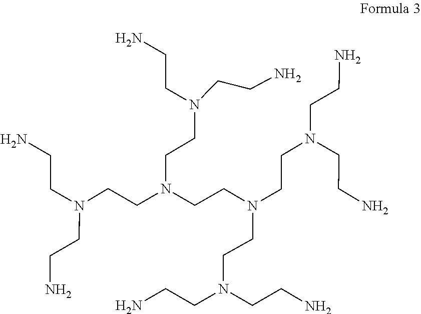 [SMILES: NCCN(CCN)CCN(CCN(CCN)CCN)CCN(CCN(CCN)CCN)CCN(CCN)CCN]

The hydrophilic polymer may comprise a hyperbranched polyamine, derivative or copolymer thereof. A hyperbranched polyamine is defined as having a structure resembling dendritic polyamine, but containing defects in the form of secondary amines (—NH—) (e.g. linear subsections as would exist in a branched polyamine), in such a way that provides a random structure instead of a symmetric dendritic structure. In a hyperbranched structure, the ratio of primary to secondary to tertiary amine amines may be about 65:5:30 to 30:10:60.

In one embodiment, the polyamine, derivative or copolymer thereof may comprise between about 10 mol % to 70 mol % primary amine (—NH₂) groups, for example at least about 10, 20, 30, 40, 50 mol % primary amine groups. The polyamine, derivative or copolymer thereof may comprise between about 10 mol % to 70 mol % secondary amine (—NH—) groups, for example at least about 10, 20, 30, 40, 50 mol % secondary amine groups. The polyamine, derivative or copolymer thereof may comprise between about 1 mol % to about 10 mol % tertiary amine

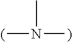

groups, for example at least about 1, 2, 5 mol % tertiary amine groups. The ratio of primary to secondary to tertiary amine groups in the polyamine, derivative or copolymer thereof may be about 10:80:10 to 60:10:30, about 60:30:10 to 30:50:20, or about 45:45:10 to 35:45:20. In one embodiment, the polyamine may comprise at least one or more aliphatic amine groups (e.g. an amine wherein no aromatic ring groups are directly bound to the nitrogen atom of the amine).

In one embodiment, the hydrophilic polymer comprises a branched polyamine, derivative or copolymer thereof. The polyamine, derivative or copolymer thereof can be cross-linked by one or more cross-linking agents described herein.

In one embodiment, the polyamine, derivative or copolymer thereof is a polyalkylenimine. In one embodiment, the polyamine is a polyalkylenimine. The polyalkylenimine may be selected from the group consisting of polyethylenimine, polypropylenimine, and polyallylamine, derivatives or copolymers thereof. Suitable polyamines that can be used to form the hydrogel may include polyethylenimine, polypropylenimine, and polyallylamine. In one embodiment, the hydrophilic polymer comprises polyethylenimine or a copolymer thereof. By using a hydrogel comprising a cross-linked polyamine (such as polyethylenimine), the hydrogel comprises a plurality of primary and secondary amine functional groups which are capable of reacting and binding to an acidic gas (e.g. CO₂ or H₂S) upon contact with a gaseous stream or atmosphere comprising the acidic gas.

In one embodiment, at least one acidic gas absorbent is incorporated within the hydrogel as one or more reactive functional groups on the cross-linked hydrophilic polymer for binding to the acidic gas. In one embodiment or example, there is provided a hydrogel for capture of acidic gas, comprising a cross-linked polyamine and a thermally conductive particulate material, wherein the thermally conductive particulate material is interspersed on or within the hydrogel, wherein the hydrogel is in the form of a particulate and incorporates one or more acidic gas absorbents.

In one embodiment or example, the hydrogel may be cross-linked polyethylenimine (PEI) hydrogel, wherein the cross-linked network comprises a plurality of primary and secondary amine functional groups which are capable of reacting and binding to an acidic gas upon contact with a gaseous stream. In one embodiment or example, there is provided a hydrogel for capture of acidic gas, comprising a cross-linked polyethylenimine (PEI) and a thermally conductive particulate material, wherein the thermally conductive particulate material is interspersed on or within the hydrogel, wherein the hydrogel is in the form of a particulate and incorporates one or more acidic gas absorbents. In some embodiments, the cross-linked polyamine is swollen with one or more liquid swelling agents as described herein, for example alcohols, polyol compounds, glycols, amines (e.g. alkanolamines, alkylamines, alkyloxyamines), piperidines, piperazines, pyridines, pyrrolidones, and derivatives or combinations thereof. Suitable alkanolamines may include monoethanolamine, diethanolamine, methyldiethanolamine, diisopropanolamine, N-ethylmonoethanolamine and aminoethoxyethanol. Suitable glycols may include ethylene glycol, Triethylene glycol, monoethylene glycol, diethylene glycol, propylene glycol, propanediol, butylene glycol, polyethylene glycol, and diglyme. Suitable alcohols may include 2-ethyoxyethanol, 2-methoxyethanol. Suitable polyol compounds may include glycerol. Suitable piperidines include piperidine, 2-methylpiperidine, 3-methylpiperidine, 4-methylpiperidine, 2-piperidineethanol (PE), 3-piperidinemthanol, and 4-piperidinemethanol. The liquid swelling agent may comprise any one or more of the above liquids.

In some embodiments, the hydrogel comprises a cross-linked polyalkylenimine selected from the group consisting of polyethylenimine, polypropylenimine, and polyallylamine, or copolymer thereof, and is swollen with a liquid swelling agent selected from the group consisting of water, monoethanolamine, diethanolamine, methyldiethanolamine, diisopropanolamine, N-ethylmonoethanolamine, aminoethoxyethanol, ethylene glycol, monoethylene glycol, diethylene glycol, triethylene glycol, propylene glycol, propanediol, butylene glycol, polyethylene glycol, glycerol, diglyme, 2-ethyoxyethanol, 2-methoxyethanol, glycerol, 2-methylpiperidine, 3-methylpiperidine, 4-methylpiperidine, 2-piperidineethanol (PE), 3-piperidinemthanol, and 4-piperidinemthanol, or a mixture thereof.

### Polyacrylamides

In some embodiments or examples, the hydrophilic polymer may comprise a polyacrylamide, derivative or copolymer thereof. As understood in the art, a polyacrylamide, derivative or copolymer is an organic compound having two or more acrylamide units. In some embodiments or examples, the polyacrylamide, derivative or copolymer thereof, may comprise copolymerisable hydrophilic monomers comprising at least two acrylamide or acrylamide derivatives to form a polyacrylamide, derivative or copolymer thereof. In another embodiment or example, the polyacrylamide copolymer, may comprise copolymerisable hydrophilic monomers comprising at least one acrylamide or acrylamide derivative and at least one carboxylic acid derivative to form a polyacrylamide copolymer.

The acrylamide derivative may be selected from N-alkyl, N-hydroxyalkyl, or N,N-dialkyl substituted acrylamide or methacrylamide. In some embodiments or examples, the polyacrylamide derivative may be selected from the group comprising N-acrylamide, methylacrylamide, N-ethylacrylamide, N-isopropylacrylamide (NiPAAm), N-octylacrylamide, N-cyclohexylacrylamide, N-methyl-N-ethylacrylamide, N-methylmethacrylamide, N-ethylmethacrylamide, N-isopropylmethacrylamide, N, N-dimethylacrylamide, N,N-diethylacrylamide, N,N-dimethylmethacrylamide, N, N-diethylmethacrylamide, N,N-dicyclohexylacrylamide, N-methyl-N-cyclohexylacrylamide, or combinations thereof. In an embodiment or example, the arylamide derivative may be selected from methacrylamide, dimethylacrylamide, N-isopropylacrylamide. N,N′-methylene-bis-acrylamide, N-2-hydroxyethylacrylamide, or combinations thereof.

The carboxylic acid derivative may be selected from the group comprising acrylic acid, methacrylic acid, methyl methacrylate, sodium acrylate, potassium acrylate, sodium methacrylate, potassium methacrylate, 2-hydroxyethyl methacrylate (HEMA), or combinations thereof.

In one embodiment or example, the acrylamide or acrylamide derivatives used in the preparation of the polyacrylamide or polyacrylamide derivative may be the same. In another embodiment or example, the acrylamide or acrylamide derivative used in the preparation of the polyacrylamide copolymer may be different. In yet another embodiment, at least one acrylamide or acrylamide derivative and at least one carboxylic acid derivative may be used in the preparation of the polyacrylamide copolymer.

In some embodiments or examples, the polyacrylamide, derivative, or copolymer thereof may be selected from the group comprising or consisting of polyacrylamide, poly(methacrylamide), poly(N-2-hydroxyethyl)acrylamide, poly(dimethylacrylamide), poly(ethylacrylamide), poly(diethylacrylamide), poly(isopropylacrylamide), poly(methylmethacrylamide), poly(ethylmethacrylamide), poly(acrylamide-co-acrylic acid), poly(acrylamide-co-sodium acrylate), poly(acrylamide-co-potassium acrylate), poly(acrylamide-co-acrylic acid) partial potassium salt, poly(acrylamide-co-acrylic acid) partial sodium salt and poly (acrylamide-co-methylenebisacrylamide).

In some embodiments or examples, the polyacrylamide, derivative or copolymer thereof may be selected from the group comprising or consisting of polyacrylamide, poly(methacrylamide), poly(dimethylacrylamide), poly(isopropylacrylamide), poly(acrylamide-co-acrylic acid), poly(acrylic acid-co-maleic acid), poly(acrylamide-co-sodium acrylate), poly(acrylamide-co-potassium acrylate), poly(acrylamide-co-acrylic acid) partial potassium salt, poly(acrylamide-co-acrylic acid) partial sodium salt and poly(acrylamide-co-methylenebisacrylamide). In some embodiments or examples, the polyacrylamide copolymer may be selected from the group comprising or consisting of poly(acrylamide-co-acrylic acid), poly(acrylamide-co-sodium acrylate), poly(acrylamide-co-potassium acrylate), poly(acrylamide-co-acrylic acid) partial potassium salt, poly(acrylamide-co-acrylic acid) partial sodium salt and poly(acrylamide-co-methylenebisacrylamide).

In some embodiments, the polyacrylamide, derivative, or copolymer thereof is a poly(acrylamide-co-acrylic acid) provided below as Formula 4 as follows:

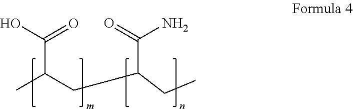

wherein:
each R is independently selected from the group consisting of hydrogen, sodium, or potassium; and
m and n are provided in a ratio in the polymer, wherein the ratio of m to n is between about 10:1 to 1:10, about 8:1 to 1:8, about 6:1 to 1:6, about 4:1 to 1:4, or about 2:1 to about 1:2. In some embodiments the ratio of m to n is between about 1:2 to 4:1, for example about 4:1.

In some embodiments, the polyacrylamide, derivative, or copolymer thereof is poly(acrylamide-co-acrylic acid), poly(acrylamide-co-sodium acrylate), poly(acrylamide-co-potassium acrylate), poly(acrylamide-co-acrylic acid) partial potassium salt, poly(acrylamide-co-acrylic acid) partial sodium salt, and poly(acrylamide-co-methylenebisacrylamide). In one embodiment, the polyacrylamide, derivative, or copolymer thereof is poly(acrylamide-co-acrylic acid),

The polyacrylamide, derivative, or copolymer thereof can be cross-linked by one or more cross-linking agents as described herein, For example, the polyacrylamide may be cross-linked with N, N-methylenebisacrylamide or ethyleneglycol dimethacrylate via a free-radical initiated vinyl polymerization mechanism. In one embodiment, the cross-linked hydrophilic polymer is poly(acrylamide-co-methylenebisacrylamide) or poly(acrylamide-co-ethyleneglycol dimethacrylate). The polyacrylamide, derivative, or copolymer thereof may also be cross-linked with an aldehyde, for example formaldehyde or glutaraldehyde.

In some embodiments, the hydrogel comprising cross-linked polyacrylamide, derivative, or copolymer thereof, may further comprise one or more metal salts. Suitable metal salts include sodium salts or potassium salts.

In some embodiments, the hydrogel comprises a cross-linked polyacrylamide, derivative, or copolymer thereof, swollen with a liquid swelling agent which is capable of reacting, binding or dissolving an acidic gas (e.g. CO₂ or H₂S) upon contact with a gaseous stream. For example, the cross-linked polyacrylamide hydrogel may be swollen with one or more liquid swelling agents as described herein, for example alcohols, polyol compounds, glycols, amines (e.g. alkanolamines, alkylamines, alkyloxyamines), piperidines, piperazines, pyridines, pyrrolidones, and derivatives or combinations thereof. Suitable alkanolamines may include monoethanolamine, diethanolamine, methyldiethanolamine, diisopropanolamine, N-ethylmonoethanolamine and aminoethoxyethanol. Suitable glycols may include ethylene glycol, monoethylene glycol, diethylene glycol, triethylene glycol, propylene glycol, propanediol, butylene glycol, polyethylene glycol, and diglyme. Suitable alcohols may include 2-ethyoxyethanol, 2-methoxyethanol. Suitable polyol compounds may include glycerol. Suitable piperidines include piperidine, 2-methylpiperidine, 3-methylpiperidine, 4-methylpiperidine, 2-piperidineethanol (PE), 3-piperidinemthanol, and 4-piperidinemthanol. The liquid swelling agent may comprise any one or more of the above liquids.

In some embodiments, the hydrogel comprises a cross-linked polyacrylamide, derivative, or copolymer thereof, swollen with a liquid swelling agent selected from the group consisting of water, monoethanolamine, diethanolamine, methyldiethanolamine, diisopropanolamine, N-ethylmonoethanolamine, aminoethoxyethanol, ethylene glycol, monoethylene glycol, diethylene glycol, triethylene glycol, propylene glycol, propanediol, butylene glycol, polyethylene glycol, glycerol, diglyme, 2-ethyoxyethanol, 2-methoxyethanol, glycerol, 2-methylpiperidine, 3-methylpiperidine, 4-methylpiperidine, 2-piperidineethanol (PE), 3-piperidinemthanol, and 4-piperidinemthanol and combinations thereof. In one embodiment, the liquid swelling agent is water, glycerol, monoethanolamine, diethanolamine, 2-piperidineethanol, ethylene glycol, triethylene glycol, or monoethyleneglycol (MEG) or combinations thereof.

In one embodiment, the hydrogel comprising a cross-linked polyacrylamide, derivative, or copolymer thereof is swollen with an alkanolamine, for example one or more of monoethanolamine, diethanolamine, methyldiethanolamine, diisopropanolamine, N-ethylmonoethanolamine and aminoethoxyethanol. In one embodiment, the hydrogel comprising a cross-linked polyacrylamide, derivative, or copolymer thereof is swollen with a piperidine, for example piperidine, 2-methylpiperidine, 3-methylpiperidine, 4-methylpiperidine, 2-piperidineethanol (PE), 3-piperidinemthanol, and 4-piperidinemthanol. In one embodiment, the hydrogel comprising a cross-linked polyacrylamide, derivative, or copolymer thereof is swollen with a glycol, for example ethylene glycol, monoethylene glycol, diethylene glycol, triethylene glycol, propylene glycol, propanediol, butylene glycol, polyethylene glycol, and diglyme. In one embodiment, the hydrogel comprising a cross-linked polyacrylamide, derivative, or copolymer thereof is swollen with a mixture comprising an alkanolamine and a glycol, for example diethanolamine and ethylene glycol, or a piperidine and a glycol, for example 2-piperidineethanol and ethylene glycol.

In one embodiment, the hydrogel comprising a cross-linked polyacrylamide, derivative, or copolymer thereof is swollen with a mixture comprising an alkanolamine and water, for example diethanolamine and water, or a piperidine and water, for example 2-piperidineethanol and water.

In one embodiment, the hydrogel comprises a cross-linked polyacrylamide, derivative or copolymer thereof and is selected from the group consisting of poly(acrylamide-co-acrylic acid), poly(acrylamide-co-sodium acrylate), poly(acrylamide-co-potassium acrylate), poly(acrylamide-co-acrylic acid) partial potassium salt, poly(acrylamide-co-acrylic acid) partial sodium salt, and poly(acrylamide-co-methylenebisacrylamide), and is swollen with a liquid swelling agent selected from the group consisting of water, monoethanolamine, diethanolamine, methyldiethanolamine, diisopropanolamine, N-ethylmonoethanolamine, aminoethoxyethanol, ethylene glycol, monoethylene glycol, diethylene glycol, triethylene glycol, propylene glycol, propanediol, butylene glycol, polyethylene glycol, glycerol, diglyme, 2-ethyoxyethanol, 2-methoxyethanol, glycerol, 2-methylpiperidine, 3-methylpiperidine, 4-methylpiperidine, 2-piperidineethanol (PE), 3-piperidinemthanol, and 4-piperidinemthanol, or a mixture thereof.

### Polyacrylates

In some embodiments or examples, the hydrophilic polymer may comprise a polyacrylate, derivative or copolymer thereof. As understood in the art, a polyacrylate, derivative or copolymer is an organic compound having two or more acrylate units. In some embodiments or examples, the polyacrylate, derivative or copolymer thereof, may comprise copolymerisable hydrophilic monomers comprising at least two acrylate or acrylate derivatives to form a polyacrylate, derivative or copolymer thereof.

The acrylate derivative may be selected from acrylate, sodium acrylate, potassium acrylate, methacrylate, sodium methacrylate, potassium methacrylate, methyl methacrylate, 2-hydroxyethyl methacrylate (HEMA), 2-hydroxyethyl acrylate (HEA), N-isopropylacrylamide, or combinations thereof.

In some embodiments, the polyacrylate, derivative or copolymer thereof may be selected from the group comprising or consisting of poly(2-hydroxyethyl methacrylate) (pHEMA), poly(2-hydroxyethyl acrylate) (pHEA), or poly(sodium acrylate). In one embodiment, the polyacrylate, derivative or copolymer thereof may be selected from the group comprising or consisting of poly(2-hydroxyethyl methacrylate) (pHEMA) or poly(2-hydroxyethyl acrylate) (pHEA). In one embodiment, the polyacrylate, derivative or copolymer thereof is poly(2-hydroxyethyl methacrylate) (pHEMA). In one embodiment, the polyacrylate, derivative or copolymer thereof is poly(2-hydroxyethyl acrylate) (pHEA).

In some embodiments, the hydrogel comprises a cross-linked polyacrylate, derivative, or copolymer thereof, swollen with a liquid swelling agent which is capable of reacting, binding or dissolving an acidic gas upon contact with a gaseous stream or atmosphere. For example, the cross-linked polyacrylate derivative, or copolymer thereof may be swollen with one or more liquid swelling agents as described herein, for example alcohols, polyol compounds, glycols, amines (e.g. alkanolamines, alkylamines, alkyloxyamines), piperidines, piperazines, pyridines, pyrrolidones, and derivatives or combinations thereof. Suitable alkanolamines may include monoethanolamine, diethanolamine, methyldiethanolamine, diisopropanolamine, N-ethylmonoethanolamine and aminoethoxyethanol. Suitable glycols may include ethylene glycol, monoethylene glycol, diethylene glycol, triethylene glycol, propylene glycol, propanediol, butylene glycol, polyethylene glycol, and diglyme. Suitable alcohols may include 2-ethyoxyethanol, 2-methoxyethanol. Suitable polyol compounds may include glycerol. Suitable piperidines include piperidine, 2-methylpiperidine, 3-methylpiperidine, 4-methylpiperidine, 2-piperidineethanol (PE), 3-piperidinemthanol, and 4-piperidinemthanol. The liquid swelling agent may comprise any one or more of the above liquids.

In some embodiments, the hydrogel comprises a cross-linked polyacrylate, derivative, or copolymer thereof, swollen with a liquid swelling agent selected from the group consisting of water, monoethanolamine, diethanolamine, methyldiethanolamine, diisopropanolamine, N-ethylmonoethanolamine, aminoethoxyethanol, ethylene glycol, monoethylene glycol, diethylene glycol, triethylene glycol, propylene glycol, propanediol, butylene glycol, polyethylene glycol, glycerol, diglyme, 2-ethyoxyethanol, 2-methoxyethanol, glycerol, 2-methylpiperidine, 3-methylpiperidine, 4-methylpiperidine, 2-piperidineethanol (PE), 3-piperidinemthanol, and 4-piperidinemthanol and combinations thereof. In one embodiment, the liquid swelling agent is water, glycerol, monoethanolamine, diethanolamine, 2-piperidineethanol, ethylene glycol, triethylene glycol, or monoethyleneglycol (MEG) or combinations thereof.

In one embodiment, the hydrogel comprising a cross-linked polyacrylate, derivative, or copolymer thereof is swollen with an alkanolamine, for example one or more of monoethanolamine, diethanolamine, methyldiethanolamine, diisopropanolamine, N-ethylmonoethanolamine and aminoethoxyethanol. In one embodiment, the hydrogel comprising a cross-linked polyacrylate, derivative, or copolymer thereof is swollen with a piperidine, for example piperidine, 2-methylpiperidine, 3-methylpiperidine, 4-methylpiperidine, 2-piperidineethanol (PE), 3-piperidinemthanol, and 4-piperidinemthanol. In one embodiment, the hydrogel comprising a cross-linked polyacrylate, derivative, or copolymer thereof is swollen with a glycol, for example ethylene glycol, monoethylene glycol, diethylene glycol, triethylene glycol, propylene glycol, propanediol, butylene glycol, polyethylene glycol, and diglyme. In one embodiment, the hydrogel comprising a cross-linked polyacrylate, derivative, or copolymer thereof is swollen with a mixture comprising an alkanolamine and a glycol, for example diethanolamine and ethylene glycol, or a piperidine and a glycol, for example 2-piperidineethanol and ethylene glycol.

In one embodiment, the hydrogel comprising a cross-linked polyacrylate, derivative, or copolymer thereof is swollen with a mixture comprising an alkanolamine and water, for example diethanolamine and water, or a piperidine and water, for example 2-piperidineethanol and water.

### Polyacrylic Acids

In some embodiments or examples, the hydrophilic polymer may comprise a polyacrylic acid, derivative or copolymer thereof. As understood in the art, a polyacrylic acid, derivative or copolymer is an organic compound having two or more acrylic acid units. In some embodiments or examples, the polyacrylic acid, derivative or copolymer thereof, may comprise copolymerisable hydrophilic monomers comprising at least two acrylic acid or acrylic acid derivatives to form a polyacryclic acid, derivative or copolymer thereof.

The acrylic acid derivative may be selected from acrylic acid or methacrylic acid, In some embodiments, the polyacryclic acid, derivative or copolymer thereof may be poly(acrylic acid) or poly(methacrylic acid).

In some embodiments, the hydrogel comprises a cross-linked polyacrylic acid, derivative, or copolymer thereof, swollen with a liquid swelling agent which is capable of reacting, binding or dissolving an acidic gas upon contact with a gaseous stream or atmosphere. For example, the cross-linked polyacrylic acid derivative, or copolymer thereof may be swollen with one or more liquid swelling agents as described herein, for example alcohols, polyol compounds, glycols, amines (e.g. alkanolamines, alkylamines, alkyloxyamines), piperidines, piperazines, pyridines, pyrrolidones, and derivatives or combinations thereof. Suitable alkanolamines may include monoethanolamine, diethanolamine, methyldiethanolamine, diisopropanolamine, N-ethylmonoethanolamine and aminoethoxyethanol. Suitable glycols may include ethylene glycol, monoethylene glycol, diethylene glycol, triethylene glycol, propylene glycol, propanediol, butylene glycol, polyethylene glycol, and diglyme. Suitable alcohols may include 2-ethyoxyethanol, 2-methoxyethanol. Suitable polyol compounds may include glycerol. Suitable piperidines include piperidine, 2-methylpiperidine, 3-methylpiperidine, 4-methylpiperidine, 2-piperidineethanol (PE), 3-piperidinemthanol, and 4-piperidinemthanol. The liquid swelling agent may comprise any one or more of the above liquids.

In some embodiments, the hydrogel comprises a cross-linked polyacrylic acid, or copolymer thereof, swollen with a liquid swelling agent selected from the group consisting of water, monoethanolamine, diethanolamine, methyldiethanolamine, diisopropanolamine, N-ethylmonoethanolamine, aminoethoxyethanol, ethylene glycol, monoethylene glycol, diethylene glycol, triethylene glycol, propylene glycol, propanediol, butylene glycol, polyethylene glycol, glycerol, diglyme, 2-ethyoxyethanol, 2-methoxyethanol, glycerol, 2-methylpiperidine, 3-methylpiperidine, 4-methylpiperidine, 2-piperidineethanol (PE), 3-piperidinemthanol, and 4-piperidinemthanol and combinations thereof. In one embodiment, the liquid swelling agent is water, glycerol, monoethanolamine, diethanolamine, 2-piperidineethanol, ethylene glycol, triethylene glycol, or monoethyleneglycol (MEG) or combinations thereof.

In one embodiment, the hydrogel comprising a cross-linked polyacrylic, derivative, or copolymer thereof is swollen with an alkanolamine, for example one or more of monoethanolamine, diethanolamine, methyldiethanolamine, diisopropanolamine, N-ethylmonoethanolamine and aminoethoxyethanol. In one embodiment, the hydrogel comprising a cross-linked polyacrylic acid, derivative, or copolymer thereof is swollen with a piperidine, for example piperidine, 2-methylpiperidine, 3-methylpiperidine, 4-methylpiperidine, 2-piperidineethanol (PE), 3-piperidinemthanol, and 4-piperidinemthanol. In one embodiment, the hydrogel comprising a cross-linked polyacrylic acid, derivative, or copolymer thereof is swollen with a glycol, for example ethylene glycol, monoethylene glycol, diethylene glycol, triethylene glycol, propylene glycol, propanediol, butylene glycol, polyethylene glycol, and diglyme. In one embodiment, the hydrogel comprising a cross-linked polyacrylic acid, derivative, or copolymer thereof is swollen with a mixture comprising an alkanolamine and a glycol, for example diethanolamine and ethylene glycol, or a piperidine and a glycol, for example 2-piperidineethanol and ethylene glycol.

In one embodiment, the hydrogel comprising a cross-linked polyacrylic acid, derivative, or copolymer thereof is swollen with a mixture comprising an alkanolamine and water, for example diethanolamine and water, or a piperidine and water, for example 2-piperidineethanol and water.

### Cross-Linker and Cross-Linking Agent

The hydrogel comprises a cross-linked hydrophilic polymer. It will be understood that some degree of cross-linking of the hydrophilic polymer is required to form the hydrogel. The rigidity and elasticity of the hydrogel can be tailored by altering the degree of cross-linking. The cross-linker promotes the formation of the 3D polymeric network, making it insoluble. The insolubilized cross-linked polymeric network allows for the adoption and retention of water and other liquids. An overview of cross-linked hydrogels is discussed in Maitra et al., American Journal of Polymer Science, 2014, 4(2), 25-31, which is incorporated herein by reference.

As used herein, the term “cross-link, “cross-linked” or “cross-linking” refers to the formation of interactions within or between hydrogel-forming polymers which result in the formation of a three-dimensional matrix. i.e. a hydrogel. For example, a polyamine may be cross-linked by 1, 3-butadiene diepoxide (BDDE) or triglycidyl trimethylolpropane ether (TTE or TMPTGE) to form a cross-linked polyamine hydrogel.

In one embodiment, the hydrogel comprises a chemically cross-linked hydrophilic polymer. Chemical cross-linked hydrogels are formed by covalent cross-linking between hydrophilic polymers. Such chemical cross-linking is achieved by using cross-linking agents capable of forming a covalent bond interactions within or between hydrophilic polymers which result in the formation of the hydrogel, including those cross-linking agents described herein. An example of a cross-linking agent that can chemically cross-link hydrophilic polymers, such as a polyamine, is an epoxide. This is in contrast to “physically cross-linked” hydrophilic polymers which refers to a type of cross-linking that is reversible in nature (i.e. not permanent) as opposed to chemically cross-linked hydrogels. Examples of physical cross-linking includes molecular entanglement of the hydrogel-forming polymer, ionic interactions, hydrogen bonding and hydrophobic interaction.

In some embodiments, the hydrophilic polymer comprises about 0.01 mol % to about 50 mol % cross-linking agent. The hydrophilic polymer may comprise at least about 0.01, 0.1, 1, 2, 5, 10, 15, 20, 25, 30, 35, 40, 45, or 50 mol % cross-linking agent. The hydrophilic polymer may comprise less than about 50, 45, 40, 35, 30, 25, 20, 15, 10, 5, 2, 1, 0.1 or 0.01 mol % cross-linking agent. Combinations of these mol % values to form various ranges are also possible, for example the hydrophilic polymer may comprise between about 0.01 mol % to about 50 mol %, about 0.01 mol % to about 20 mol %, or about 0.01 mol % to about 10 mol % cross-linking agent.

In some embodiments, the hydrogel comprises between about 0.1 wt. % to about 20 wt. % cross-linking agent based on the total weight of the hydrogel. In some embodiments, the hydrogel comprises at least about 0.1, 1, 2, 3, 4, 5, 6, 8, 10, 15 or 20 wt. % cross-linking agent based on the total weight of the hydrogel. In other embodiments, the hydrogel comprises less than about 20, 15, 20, 15, 10, 8, 6, 5, 3, 2, 1, or 0.1 wt. % cross-linking agent based on the total weight of the hydrogel. Combinations of these wt. % values to form various ranges are also possible, for example the hydrogel in comprises between about 1 wt. % to about 20 wt. %, between about 10 wt. %, or between about 1 wt. % to about 6 wt. % cross-linking agent based on the total weight of the hydrogel. According to some embodiments or examples described herein, hydrogels comprising higher amounts of cross-linking agent (e.g. 1 wt. % or more) demonstrated good regeneration properties.

Accordingly, in some embodiments, the hydrogel comprises between about 0.05 wt. % to about 50 wt. % cross-linked hydrophilic polymer based on the total weight of the hydrogel. In some embodiments, the hydrogel comprises at least about 0.01, 0.05, 0.1, 0.2, 0.5, 1, 2, 5, 10, 15, 20, 25, 30, 35, 40, 45, or 50 wt. % cross-linked hydrophilic polymer based on the total weight of the hydrogel. In other embodiments, the hydrogel comprises less than about 50, 45, 40, 35, 30, 25, 20, 15, 10, 5, 2, 1, 0.5, 0.2, 0.1, 0.05 or 0.01 wt. % cross-linked hydrophilic polymer based on the total weight of the hydrogel. Combinations of these cross-linked hydrophilic polymer to form various ranges are also possible, for example the hydrogel comprises between about 0.01 wt. % to about 50 wt. 30%, about 0.05 wt. % to about 50 wt. %, about 1 wt. % to about 50 wt. %, about 0.05 wt. % to about 25 wt. %, about 10 wt. % to about 50 wt. %, about 10 wt. % to about 40 wt. %, or about 30 wt. % to about 50 wt. % cross-linked hydrophilic polymer based on the total weight of the hydrogel.

In one embodiment, the dry or dehydrated hydrogel may comprise between about 80 wt. % to about 99.9 wt. % cross-linked hydrophilic polymer based on the total weight of the dehydrated hydrogel.

The swelling ability of the hydrogel is dependent on the nature of the cross-linked hydrophilic polymer and the solvent that is swelling the hydrogel. For example, a hydrogel with long hydrophilic cross-links may swell more than an analogous cross-linked polymer network with shorter hydrophobic cross-links.

The cross-linking agent may be selected to provide an alkyl cross-linker, heteroalkyl cross-linker, cycloalkyl cross-linker, arylalkyl cross-linker, or heteroarylalkyl cross-linker, in the cross-linked hydrophilic polymer, each of which may be optionally substituted and/or optionally interrupted as described herein. The cross-linking agent may comprise between about 1 and 30 carbon atoms and may be optionally substituted and/or optionally interrupted as described herein.

In some embodiments, the cross-linking agent is selected to provide an alkyl cross-linker in the cross-linked hydrophilic polymer. The alkyl cross-linker may be optionally substituted with one or more functional groups selected from alkyl, halo, haloalkyl, hydroxyl, or amine, and optionally interrupted with one or more 0, N, Si or S. In one example, the cross-linker is substituted with one or more hydroxyl groups. The presence of one or more hydroxyl groups on the cross-linker can further improve the binding and absorption of an acidic gas (e.g. CO₂) in the hydrogel, at least according to some examples as described herein.

In some embodiments, the cross-linking agent may be selected to provide a C₁-C₂₀alkyl cross-linker in the cross-linked hydrophilic polymer. It will be appreciated that the C₁₋₂₀alkyl cross-linker may be provided by any alkyl as described above or herein having a 1 to 20 atom chain. For example, the C₁₋₂₀alkyl cross-linker may be optionally substituted with one or more functional groups selected from at least alkyl, halo, haloalkyl, hydroxyl, or amine, and optionally interrupted with one or more O, N, Si or S. In other examples the cross-linking agent may be a C₂-C₂₀alkyl, C₅-C₂₀alkyl, C₁₀-C₂₀alkyl or C₁₂-C₁₀alkyl, according to any example as described herein.

In some embodiments, the cross-linking agent may be selected to provide a C₁-C₁₀alkyl cross-linker in the cross-linked hydrophilic polymer. It will be appreciated that the C₁₋₁₀alkyl cross-linker may be provided by any alkyl as described above or herein having a 1 to 10 atom chain. For example, the C₁₋₁₀alkyl cross-linker may be optionally substituted with one or more functional groups selected from at least alkyl, halo, haloalkyl, hydroxyl, or amine, and optionally interrupted with one or more O, N, Si or S. In other examples the cross-linking agent may be a C₂-C₁₀alkyl, C₃-C₁₀alkyl, C₄-C₁₀alkyl or C₅-C₁₀alkyl, according to any example as described herein.

The cross-linking agent may be selected to provide a heteroalkyl cross-linker in the cross-linked hydrophilic polymer. The heteroalkyl group may be provided by an alkyl as described herein or any example thereof, which is interrupted by one or more heteroatoms (e.g. 1 to 3). The heteroatoms may be selected from any one or more of O, N, Si, S.

The cross-linking agent may be selected to provide a cycloalkyl cross-linker in the cross-linked hydrophilic polymer. The cycloalkyl cross-linker may be optionally substituted with one or more functional groups selected from alkyl, halo, haloalkyl, hydroxyl, or amine, and optionally interrupted with one or more O, N, Si or S. The cycloalkyl group may be an alkylcycloalkyl group, for example. The cycloalkyl group may have 1-3 cyclic groups linked and/or fused together.

The cross-linking agent may be selected to provide an arylalkyl cross-linker in the cross-linked hydrophilic polymer. The arylalkyl cross-linker may be optionally substituted with one or more functional groups selected from any one or more of halo, haloalkyl, hydroxyl, carboxyl, or amine, and optionally interrupted with any one or more O, N, Si or S. The arylalkyl cross-linker may have 1 to 3 aryl groups, for example, each of which may be linked and/or fused together.

The cross-linking agent may be selected to provide a heteroarylalkyl cross-linker in the cross-linked hydrophilic polymer. It will be appreciated that the heteroarylalkyl may be any arylalkyl group that is interrupted by one or more heteroatoms. The heteroatoms may be selected from any one or more of O, N, Si, S.

In some embodiments, the cross-linking agent is an epoxide (i.e. an epoxide cross-linker). For example, the epoxide can provide a bivalent or polyvalent linking group in the cross-linked hydrophilic polymer, which may comprise one or more hydroxyl groups arising from reaction of the epoxide groups with the hydrophilic polymer. In some embodiments, the cross-linking agent comprises at least 1, 2, 3, 4 or 5 epoxides. In some embodiments, the cross-linking agent comprises 2 epoxides. In one embodiment, the cross-linking agent is an epoxide. In one embodiment the epoxide is a diepoxide (e.g. comprises 2 epoxide groups, for example BDDE). In one embodiment, the epoxide is a triepoxide (e.g. comprises 3 epoxide groups, for example TTE). In one embodiment, the cross-linking agent is 1, 3-butadiene diepoxide (BDDE) or triglycidyl trimethylolpropane ether (TTE or TMPTGE). In some embodiments, the hydrogel comprises a cross-linked polyamine or copolymer thereof. In some embodiments, the hydrogel comprises a cross-linked polyacrylamide or co-polymer thereof. In some embodiments, the hydrogel comprises a cross-linked polyamine or a cross-linked polyacrylamide, or copolymers thereof.

The cross-linking agent may be selected from the group consisting of triglycidyl trimethylolpropane ether (TTE or TMPTGE) (also referred to as trimethylolpropane triglycidyl ether), diglycidyl ether, Resorcinol diglycidyl ether (CAS Number: 101-90-6), Bisphenol A diglycidyl ether, 1, 3-Butadiene diepoxide, Diglycidyl 1,2-cyclohexanedicarboxylate, Diglycidyl hexahydrophthalate, Poly(ethylene glycol) diglycidyl ether average (<Mn 1000), Glycerol diglycidyl ether, 1,4-Butanediol diglycidyl ether, Bisphenol F diglycidyl ether, Bisphenol A propoxylate diglycidyl ether, Bisphenol A propoxylate diglycidyl ether PO/phenol 1, N,N-Diglycidyl-4-glycidyloxyaniline, N,N-Diglycidyl-4-glycidyloxyaniline, Poly(dimethylsiloxane), diglycidyl ether terminated (Mn<1000), Neopentyl glycol diglycidyl ether, 2,2-Bis[4-(glycidyloxy)phenyl]propane, 4,4′-Isopropylidenediphenol diglycidyl ether, BADGE, Bisphenol A diglycidyl ether, D.E.R.™ 332, Bis[4-(glycidyloxy)phenyl]methane, Tris(4-hydroxyphenyl)methane triglycidyl ether, Tris(2,3-epoxypropyl) isocyanurate, 4,4′-Methylenebis(2-methylcyclohexylamine).

Other suitable cross linking agents may also comprise one or more isothiocyanates, isocyanates, acyl azides, NHS esters, sulfonyl chlorides, aldehydes, glyoxals, epoxides, oxiranes, carbonates, aryl halides, imidoesters, carbodiimides, anhydrides, acrylates, acrylamides, diamines, and fluorophenyl ester groups.

The cross-linking agent may comprise an aldehyde group, for example at least one, two, or three aldehyde groups. For example, the cross-linking agent may be formaldehyde or glutaraldehyde. In one embodiment, the hydrophilic polymer is a polyacrylamide, derivative, or copolymer thereof cross-linked with an aldehyde, for example formaldehyde or glutaraldehyde.

The cross-linking agent may comprise two or more vinyl groups (—C═CH₂). For example, the cross-linking agent may be a divinyl cross-linking agent, such as N, N-methylenebisacrylamide or ethyleneglycol dimethacrylate. In some embodiments, the hydrophilic polymer is a polyacrylamide, derivative, or copolymer thereof, cross-linked with N, N-methylenebisacrylamide via a free-radical initiated vinyl polymerization mechanism, for example to form a poly(acrylamide-co-methylenebisacrylamide) hydrogel or poly(N-2-hydroxethyl)acrylamide hydrogel that is held together by covalent bonds.

In some embodiments, a free radical initiator and/or catalyst may be added to initiate/catalyse the radical polymerisation. Suitable catalysts include diamines, such as N,N,N′,N′-tetramethyldiaminomethane, N,N,N′,N′-tetraethylmethanediamine, N,N,N′,N′-tetramethyl-1,3-propanediamine, or N,N,N′,N′-tetramethyl-1,4-butanediamine. Suitable initiators include peroxysulfates, peroxyphosphates, peroxycarbonates, alkyl peroxides, acyl peroxides, hydroperoxides, ketone peroxides, peresters, azo compounds, azides, etc., e.g., diethyl peroxydicarbonate, ammonium persulfate, potassium persulfate, potassium peroxyphosphate, t-butyl peroxide, acetyl peroxide, t-butyl hydroperoxide, methyl ethyl ketone peroxide, dimethylperoxalate, azo-bis(isobutyronitrile), benzenesulfonylazide, 2-cyano-2-propyl-azo-formamide, azo-bisisobutyramidine dihydrochloride (or as free base), azobis-(N,N′-dimethyleneisobutyramidine-dihydrochloride (or as free base), and 4,4′-azo-bis(4-cyanopentanoic acid).

In some embodiments, the cross-linking agent is a diacrylate or a diacrylamide.

Other examples of suitable cross-linking agents include ethylene glycol dimethacrylate, piperazine diacrylamide, PEG diacrylate, ethyleneglycol dimethacrylate, diethyleneglycol diacrylate, triethyleneglycol diacrylate.

In one embodiment, the cross-linked hydrophilic polymer comprises poly(acrylamide-co-acrylic acid) or a partial sodium or potassium salt thereof, that is cross-linked with 1-ethyl-3-(3-dimethylaminopropyl)carbodiimide (EDC) and N-hydroxysuccinimide (NHS) and multifunctional amines.

The hydrophilic polymer may be ionically-cross linked (e.g. linked by ionic interactions (i.e. an electrostatic attraction between oppositely charged ions). For example, the ionic-cross linking may be a charge interaction between the hydrophilic polymer and an oppositely charged molecule as the linker. This charged small molecule may be a polyvalent cation or anion. The oppositely charged molecule may also be a polymer. The ionic-cross linking may also be between two hydrogel forming polymers of the opposite charge. In some embodiments, the hydrophilic polymer is cross-linked by metallic cross-linking agent, for example a polyvalent cation. The term “polyvalent cation” refers to a cation with a positive charge equal or greater than +2. In some embodiments, the hydrogel is ionically cross-linked by divalent cations or trivalent cations, or mixtures thereof. In some embodiments, the polyvalent cation is a divalent cation. As used herein, the term “divalent cation” is intended to mean a positively charged element, atom or molecule having a valence of +2. The divalent cation may be selected from one or more of Ca²⁺, Mg²⁺, Sr²⁺, Ba²⁺, Zn²⁺, or Be²⁺, and salt forms of these cations (e.g. CaCl₂)). In other embodiments, the polyvalent cation is a trivalent cation. As used herein, the term “trivalent cation” is intended to mean a positively charged element, atom, or molecule having a valence of +3. The trivalent cation may be selected from one or more of Fe³⁺, Cr³⁺, Al³⁺, or Mn³⁺, and salt forms of these cations (e.g. AlCl₃). In some embodiments, the cross-linking agent is a mixture of both divalent and trivalent cations, both of which may be selected from the cations as described herein.

In one embodiment, at least one acidic gas absorbent is incorporated within the hydrogel as one or more reactive functional groups on the cross-linked hydrophilic polymer for binding to the acidic gas and at least one acidic gas absorbent is incorporated within the hydrogel as part of a liquid swelling agent absorbed within the hydrogel.

In one embodiment, where the hydrogel incorporates an acidic gas absorbent as one or more reactive functional groups on the cross-linked hydrophilic polymer for binding to the acidic gas and incorporates an acidic gas absorbent as part of a liquid swelling agent absorbed within the hydrogel, the acidic gas absorbent is the same (e.g. the hydrogel may comprise a cross-linked hydrophilic polymer having one or more amine functional groups capable of binding to the acidic gas, and is swollen with a liquid amine, for example the hydrogel comprises a cross-linked polyethylenimine swollen with a diethanolamine liquid swelling agent).

In another embodiment, where the hydrogel incorporates an acidic gas absorbent as one or more reactive functional groups on the cross-linked hydrophilic polymer for binding to the acidic gas and incorporates an acidic gas absorbent as part of a liquid swelling agent absorbed within the hydrogel, the acidic gas absorbent is the different (e.g. the hydrogel comprises a cross-linked hydrophilic polymer having one or more amine functional groups capable of binding to the acidic gas, and is swollen with liquid swelling agent capable of absorbing acidic gas by a physical process, such as methanol).

### Processes for Preparing Hydrogels

The present disclosure also provides a process for preparing the hydrogels described herein.

The process may comprise mixing a solution comprising a hydrophilic polymer and a cross-linking agent under conditions effective to cross-link the hydrophilic polymer to form the hydrogel, and wherein the process comprises mixing a particulate material having a thermal conductivity with the hydrophilic polymer and cross-linking agent or contacting the hydrogel with a particulate material under conditions effective to intersperse the particulate material on or within the hydrogel.

In one embodiment, the process comprises mixing a solution comprising a hydrophilic polymer, a particulate material having a thermal conductivity and a cross-linking agent under conditions effective to cross-link the hydrophilic polymer to form the hydrogel, wherein the particulate material is interspersed on or within the hydrogel. In some embodiments, the particulate material is mixed with the solution comprising the hydrophilic polymer solution prior to addition of the cross-linking agent.

In some embodiments, the particulate material is mixed with the cross-linking agent prior to addition to the hydrophilic polymer solution. In an alternative embodiment, the process comprises 1) preparing a solution comprising the hydrophilic polymer; 2) mixing the thermally conductive material with solution comprising the hydrophilic polymer, and 3) adding a solution comprising the cross-linking agent to the mixture comprising the hydrophilic polymer and thermally conductive material under conditions effective to cross-link the hydrophilic polymer to form the hydrogel, wherein the thermally conductive material is interspersed on or within the hydrogel.

In one embodiment, the process comprises 1) preparing a solution comprising the hydrophilic polymer; 2) mixing the thermally conductive material with a solution comprising the cross-linking agent, and 3) adding the solution comprising the cross-linking agent and thermally conductive particulate material to the hydrophilic polymer solution under conditions effective to cross-link the hydrophilic polymer to form the hydrogel, wherein the thermally conductive material is interspersed on or within the hydrogel.

In a related embodiment, the interspersion of the thermally conductive particulate material on or within the hydrogel may occur in-situ (i.e. during the cross-linking of the hydrophilic polymer), and the thermally conductive particulate material may be interspersed within the cross-linked hydrophilic polymer or on the surface of the hydrogel. According to some embodiments or examples described herein, in-situ interspersion of the thermally conductive particulate material during cross-linking of the hydrophilic polymer may provide a uniform dispersion of the particulate material throughout the hydrogel and provide improved heat transfer properties.

Alternatively, the process may comprise mixing a solution comprising a hydrophilic polymer and a cross-linking agent under conditions effective to cross-link the hydrophilic polymer to form the hydrogel, and wherein the process comprises contacting the hydrogel with a particulate material under conditions effective to intersperse the particulate material on or within the hydrogel.

In one embodiment, the process comprises 1) preparing a solution comprising the hydrophilic polymer; 2) adding a solution comprising the cross-linking agent to the hydrophilic polymer solution under conditions effective to form a hydrogel; and 3) contacting the hydrogel with the thermally conductive particulate material, wherein the particulate material is interspersed on or within the surface of the hydrogel.

In a related embodiment, the interspersion of the thermally conductive particulate material on or within the hydrogel may occur ex-situ (i.e. as a separate step to the cross-linking of the hydrophilic polymer), and the thermally conductive particulate material may be interspersed on the surface of the hydrogel.

The thermally conductive particulate material may be interspersed on the surface of the hydrogel, for example as a particulate layer on the surface of the hydrogel. In one embodiment, the hydrogel is in the form of a plurality of particles, wherein at least some of the particles comprise thermally conductive particulate material interspersed on the surface (e.g. intercalated or embedded onto the surface) of the particles as a particulate coating layer. Without wishing to be bound by theory, it is believed the particulate material adheres to the surface of the hydrogel and can be incorporated or embedded into one or more interstitial voids located at the surface of the hydrogel.

The conditions effective to cross-link the hydrophilic polymer to form the hydrogel and/or to intersperse the particulate material on or within the hydrogel are described herein. Regardless as to how the thermally conductive particles are interspersed on or within the hydrogel (e.g. in-situ or ex-situ), it will be appreciated that the thermally conductive particulate material is interspersed on or within the hydrogel. The hydrophilic polymer, cross-linking agent and thermally conductive material is described herein.

In some embodiments, the thermally conductive particulate material is reduced in size prior to mixing with the cross-linking agent and hydrophilic polymer (e.g. in-situ interspersion) or prior to contacting with the hydrogel (e.g. ex-situ interspersion)

The hydrophilic polymer and cross-linking agent may be mixed at a suitable temperature effective to cross-link the hydrophilic polymer to form the hydrogel. In one embodiment, the hydrophilic polymer and cross-linking agent may be mixed at a temperature of between about 10° C. to about 50° C. to cross-link the hydrophilic polymer to form the hydrogel. The hydrophilic polymer and cross-linking agent may be mixed at a temperature of at least about 10, 12, 15, 17, 20, 22, 25, 28, 30, 35, 40, 45 or 50° C. to cross-link the hydrophilic polymer to form the hydrogel. The hydrophilic polymer and cross-linking agent may be mixed at a temperature of less than about 50, 45, 40, 35, 30, 28, 25, 22, 20, 17, 15, 12 or 10° C. to cross-link the hydrophilic polymer to form the hydrogel. The mixing temperature may be in a range provide by any two of these upper and/or lower values. In some embodiments, the mixing temperature is about about 10, 12, 15, 17, 20, 22, 25, 28, 30, 35, 40, 45 or 50° C. to cross-link the hydrophilic polymer to form the hydrogel.

The hydrophilic polymer and cross-linking agent may be mixed for a period of time effective to cross-link the hydrophilic polymer to form the hydrogel. In one embodiment, the hydrophilic polymer and cross-linking agent are mixed for a period of time of about 5 min to about 60 min to cross-link the hydrophilic polymer to form the hydrogel. In some embodiments, the hydrophilic polymer and cross-linking agent are mixed for a period of time of at least about 5, 10, 15, 20, 25, 30, 35, 40, 45, 50, 55, or 60 min. of about 5 min to about 60 min to cross-link the hydrophilic polymer to form the hydrogel. The hydrophilic polymer and cross-linking agent may be mixed for a period of time of at less than about 60, 55, 50, 45, 40, 35, 30, 25, 20, 15, or 10 min to cross-link the hydrophilic polymer to form the hydrogel. The mixing time may be in a range provide by any two of these upper and/or lower values. In some embodiments, the mixing time is about 5, 10, 15, 20, 25, 30, 35, 40, 45, 50, 55, or 60 min to cross-link the hydrophilic polymer to form the hydrogel.

In some embodiments, one or more other additives may be added to the hydrophilic polymer and cross-linking agent, including for example an initiator and/or catalyst as described herein. For example, where the conditions effective to form the hydrogel comprise free-radical polymerization, it will be appreciated that an initiator (e.g. potassium persulfate) and/or catalyst (e.g. N,N,N′,N′-tetramethyldiaminomethane) can be added to initiate/catalyse the polymerisation and cross-linking of the hydrophilic polymer (e.g. PHEAA hydrogels). Alternatively, in other embodiments, the cross-linking of the hydrophilic polymer does not require the presence of an initiator and/or catalyst (e.g. cross-linked PEI hydrogels).

For the in-situ interspersion of the thermally conductive particulate material on or within the hydrogel described herein, the conditions effective to intersperse the particulate material on or within the hydrogel may be the same as the conditions effective to cross-link the hydrophilic polymer to form the hydrogel.

For the ex-situ interspersion of the thermally conductive particulate material on or within the hydrogel described herein, the particulate material may be mixed with the hydrogel under conditions effective to intersperse the particulate material on or within the hydrogel. In one embodiment, the thermally conductive particulate material is mixed with the hydrogel for a period of time effective to intersperse the particulate material on or within the hydrogel. In one embodiment, the particulate material and hydrogel is mixed for at least about 0.5, 1, 2, 3, 4, 5, 6, 7, 8, 9, 10, 12, 15, 20, 30, 60, 90, 120 or 180 minutes to intersperse the particulate material on or within the hydrogel. In one embodiment, the particulate material and hydrogel is mixed for at least about 180, 120, 90, 60, 30, 20, 15, 12, 10, 9, 8, 7, 6, 5, 4, 3, 2, 1 or 0.5 minutes to intersperse the particulate material on or within the hydrogel. A range may be provided by any two of these upper and/or lower values. The mixing may comprise any suitable process, for example blending, grinding, or crushing.

In one embodiment, the process further comprises the step of grinding/crushing the hydrogel to form a plurality of hydrogel particles (i.e. a particulate). Any suitable technique can be used to ground the hydrogel, for example using a mortar and pestle. The hydrogel may have a particle size as described herein. The hydrogel may be ground/crushed prior to contact with the thermally conductive particulate material. Alternatively, the hydrogel may be ground/crushed comprising the thermally conductive particulate material.

The hydrogel described herein may have a roughened or textured surface which can provide an enhanced surface area which can facilitate the interspersion of the particulate material on or within the surface of the hydrogel. In some embodiments, the thermally conductive particulate material may be interspersed on or within the hydrogel particles roughened surface (e.g. intercalated, interspersed or embedded into the roughened surface of the hydrogel particles). The surface roughness may be provided by crushing/grinding the hydrogel into particles, wherein the particles comprise a roughened surface.

In some embodiments, the solution comprising the hydrophilic polymer and/or the cross-linking agent, is selected from an aqueous solution or a liquid swelling agent, or mixture thereof. The solution comprising the hydrophilic polymer may be the same as or different to the solution comprising the cross-linking agent.

In one embodiment, the process further comprises the step of dehydrating the hydrogel to remove the solution (e.g. the aqueous solution used to mix the hydrophilic polymer, cross-linking agent and thermally conductive material). In a further embodiment, the dehydrated hydrogel may be swollen with one or more of the liquid swelling agents described herein. Alternatively, the hydrogel may be prepared using one or more of the liquid swelling agents described herein.

### Gaseous Streams and Atmospheres

The hydrogels of the present disclosure can remove an acidic gas from a gaseous stream or atmosphere containing the acidic gas, and may be used in absorption of acidic gas in a range of industrial processes such as in removing acidic gas from pre-combustion processes such as from hydrocarbon gases, removal of acidic gas from combustion gases, reducing acidic gas produced in manufacture of products, or may be used in reducing the acidic gas content of ambient air. The acidic gas (e.g. CO₂ or H₂S) may be removed from the gaseous stream or atmosphere by being absorbed into the hydrogel. For example, the acidic gas may be absorbed into the hydrogel by a chemical or physical process. In some embodiments, the cross-linked hydrophilic polymer comprises one or more functional groups capable of binding to the acidic gas. Alternatively or additionally, the hydrogel may comprise a liquid swelling agent, wherein the liquid swelling agent absorbs the acidic gas. The acidic gas may be a contaminant in a hydrocarbon gas stream. In one embodiment, the acidic gas is CO₂ or H₂S, or a mixture thereof. In one embodiment, the acidic gas is a nitrogen oxide gas (e.g. NOx). NOx indicates the entire family of nitrogen oxides, typically produced during combustion processes with the use of oxygen. NOx contaminants include nitrogen monoxide (NO), nitrogen dioxide (NO₂), dinitrogen trioxide (N₂O₃) and so on. In one embodiment, the acidic gas is selected from the group consisting of carbon dioxide (CO₂), sulfur dioxide (SO₂), hydrogen sulfide (H₂S) and a nitrogen oxide (NOx), or mixtures thereof.

The acidic gas may be a component of a natural gas, such as acid gas which is understood to be a natural gas mixture that contains significant quantities of acidic gases, namely, H₂S or CO₂. The acid gas may be sour gas, which is a specific type of acid gas that contains a significant amount of H₂S. In one embodiment, the acidic gas may be a contaminant in a hydrocarbon gas. Although the term ‘hydrocarbon gas’ general refers to natural gas, it will be appreciated by those skilled in the art that the term may equally apply to coal seam gas, associated gas, nonconventional gas, landfill gas, biogas, and flue gas. Alternatively, the acidic gas may be a component of lower acidic gas concentration gaseous streams or atmospheres, such as ambient air.

The gaseous stream or atmosphere may be any stream or atmosphere in which separation of one or more acidic gases from stream or atmosphere is desired. Examples of streams or atmospheres include product gas streams e.g. from coal gasification plants, reformers, precombustion gas streams, post-combustion gas streams (including in-line post combustion gas streams) such as flue gases, the exhaust streams from fossil-fuel burning power plants, sour natural gas, post-combustion, emissions from incinerators, industrial gas streams, exhaust gas from vehicles, exhaust gas from sealed environments such as submarines and the like. In one embodiment, the gaseous stream or atmosphere is selected from the group consisting of combustion flue gas, hydrocarbon gas mixture, emission from cement or steel production, biogas and ambient air.

In some embodiments, the gaseous stream or atmosphere may have an acidic gas concentration of less than about 200,000 parts per million (ppm). In one embodiment, the gaseous stream or atmosphere may have an acidic gas concentration of less than 150,000, 100,000, 75,000, 50,000, 25,000, 10,000, 5,000, 4,000, 1,000, 900, 800, 700, 600, 500, 400, 300, 200 or 100 ppm. In another embodiment, the gaseous stream or atmosphere may have an acidic gas concentration of between about 100 ppm to 100,000 ppm, about 100 ppm to about 10,000 ppm, or about 100 ppm to about 5,000 ppm. It will be understood that 1 ppm equates to 0.0001 vol. %. For example, a gaseous stream or atmosphere having an acidic gas concentration of less than about 100,000 ppm equates to 10.0 vol. % of acidic gas in the gaseous stream.

### Low CO₂ Concentration Gaseous Streams or Atmospheres.

The hydrogels of the present disclosure can remove CO₂ from low CO₂ concentration gaseous streams or atmospheres. For example, the process can remove CO₂ from a low CO₂ concentration gaseous stream or atmosphere. Examples of low concentration gaseous streams or atmospheres include the atmosphere (e.g. ambient air), ventilated air (e.g. air conditioning units and building ventilation), and partly closed systems which recycle breathing air (e.g. submarines or rebreathers). In some embodiments, the low CO₂ concentration gaseous stream or atmosphere may have a CO₂ concentration of less than about 200,000 parts per million (ppm). In one embodiment, the low CO₂ concentration gaseous stream or atmosphere may have a CO₂ concentration of less than 150,000, 100,000, 75,000, 50,000, 25,000, 10,000, 5,000, 4,000, 1,000, 900, 800, 700, 600, 500, 400, 300, 200 or 100 ppm. In another embodiment, the low CO₂ concentration gaseous stream or atmosphere may have a CO₂ concentration of between about 100 ppm to 100,000 ppm, about 100 ppm to about 10,000 ppm, about 100 ppm to about 5,000 ppm, about 100 ppm to about 1,000 ppm or about 100 ppm to about 500 ppm. In one embodiment, the low CO₂ concentration gaseous stream or atmosphere may have a CO₂ concentration of between about 200 ppm to about 500 μm, such as about 400 to 450 ppm.

In some embodiments, the low CO₂ concentration gaseous stream or atmosphere may have a CO₂ concentration of less than about 20, 15, 10, 7.5, 5, 2.5, 1, 0.5, 0.1, 0.09, 0.08, 0.07, 0.06, 0.05, 0.04, 0.03, 0.02 or 0.01 vol. %. In another embodiment, the low CO₂ concentration gaseous stream or atmosphere may have a CO₂ concentration of between about 0.01 vol. % to about 10 vol. %, about 0.01 vol. % to about 1 vol. %, about 0.01 vol. % to about 0.1 vol. %, or 0.01 vol. % to about 0.05 vol. %. In one embodiment, the low CO₂ concentration gaseous stream or atmosphere may have a CO₂ concentration of between about 0.02 vol. % to about 0.05 vol. %, such as about 0.04 vol. %.

In one embodiment, the low CO₂ concentration gaseous stream or atmosphere may have a CO₂ concentration the same as in ambient air (e.g. the atmosphere). Thus in one embodiment, the low CO₂ concentration gaseous stream or atmosphere may have a CO₂ concentration of about 400 ppm to 450 ppm CO₂, for example about 400 ppm to 415 ppm as in ambient air in most locations around the world. Accordingly, in one embodiment, the process is for direct air capture (DAC).

In one embodiment or example, the process is for direct air capture in indoor sealed environments (DACi). Thus, the CO₂ concentration gaseous stream or atmosphere may have a CO₂ concentration of up to 2,000 ppm.

In one embodiment or example, the process is for direct air capture in external power plants (DACex). Thus, the CO₂ concentration gaseous stream or atmosphere may have a CO₂ concentration of about 3,000 ppm to about 150,000 ppm.

In one embodiment or example, the gaseous stream or atmosphere may comprise less than 100 ppm (i.e. 0.01 vol. %) hydrocarbon gas. In one embodiment, the gaseous stream or atmosphere may comprise less 10, 8, 5, 2, 1, 0.5, 0.1 or 0.01 vol. % hydrocarbon gas. In one embodiment, the gaseous stream or atmosphere may comprise less than 100 ppm (i.e. 0.01 vol. %) hydrocarbon gas. For example, the gaseous stream or atmosphere may comprise less than about 100, 75, 50, 25, 20, 15, 10, 5, 4, 3, or 2 ppm hydrocarbon gas. The term ‘hydrocarbon gas’ will be understood to refer to a gaseous mixture of hydrocarbon compounds including, but not limited to methane, ethane, ethylene, propane, and other C3+ hydrocarbons. For example, it will be understood by a person skilled in the art that ambient air comprises methane as a minor impurity (e.g. 2 ppm/0.0002 vol. %), and that ambient air therefore may comprise less than 3 ppm hydrocarbon gas. The low CO₂ concentration gaseous stream or atmosphere may comprise predominantly of nitrogen makes up the major vol. % proportion in the gaseous stream. For example, the low CO₂ concentration gaseous stream or atmosphere may comprise at least about 50 vol. % nitrogen, for example at least about 70 vol. % nitrogen. In one embodiment, the low CO₂ concentration gaseous stream comprises about 78 vol. % nitrogen (e.g. ambient air).

The low CO₂ concentration gaseous stream or atmosphere may comprise an amount of water (e.g. the gaseous stream is damp/moist for example a humid gaseous stream). For example, the low CO₂ concentration gaseous stream or atmosphere may comprise between about 1 vol. % to about 10 vol. % water. Alternatively, the low CO₂ concentration gaseous stream or atmosphere may be a dry gaseous stream.

In an alternate embodiment, the process can capture CO₂ from a high CO₂ concentration gaseous stream or atmosphere. For example, the high CO₂ concentration gaseous stream or atmosphere may have a CO₂ concentration of 925 mbar (100 vol. %).

In some embodiments, the gaseous stream or atmosphere originates from a ventilation system, for example building ventilation or air conditioning. In other embodiments, the gaseous stream or atmosphere originates from a closed, or at least partially closed system, designed to recycle breathing gas, for example in a submarine, space craft, or aircraft. It will be appreciated that the hydrogels of the present disclosure can also absorb CO₂ from gaseous streams or atmospheres with higher CO₂ concentrations, highlighting the versatility of the hydrogels for a wide range of air capture applications. In an example, it is the ability of the hydrogels to capture CO₂ at relatively low concentrations (e.g. 400 ppm) which the present inventors found particularly surprising.

The low CO₂ concentration gaseous stream or atmosphere is contacted with the hydrogel. The gaseous stream or atmosphere may have a suitable flow rate to contact (e.g. pass through) the hydrogel. Alternatively, the gaseous stream or atmosphere may come into contact with the hydrogel without any back pressure or flow rate being applied (e.g. the gaseous stream may organically diffuse into the hydrogel upon contact). In some embodiments, the gaseous stream or atmosphere may be an atmosphere surrounding the hydrogel, for example a low CO₂ concentration atmosphere. In some embodiments, the gaseous stream or atmosphere passes through the hydrogel (e.g. enters from a first side or face on the hydrogel and exits from different side or face) or it may simply diffuse into the hydrogel, for example when the hydrogel is placed in an atmosphere, such as ambient air. As such, it will be understood that in some embodiments the gaseous stream does not need to be applied with a back pressure to essentially force the gaseous stream “through” the hydrogel, although in some embodiments this may be desirable, such as when the hydrogel is configured to a building ventilation system, for example. In one embodiment, the gaseous stream (e.g. atmosphere) diffuses into the hydrogel upon contact with the hydrogel.

In some embodiments, the gaseous stream or atmosphere has no flow rate, e.g. 0 m³/hour. In some embodiments, or examples, the gaseous stream has a flow rate of between about 0.01 m³/hr to about 50,000 m³/hr. The flow rate may be at least 0.01, 0.05, 0.1, 0.5, 1, 5, 10, 20, 30, 40, 50, 60, 70, 80, 90, 100, 200, 300, 400, 500, 600, 700, 800, 900 1,000, 2,000, 3,000, 4,000, 5,000, 6,000, 7,000, 8,000, 9,000, 10,000, 15,000, 17,000, 20,000, 30,000, 40,000, or 50,000 cubic metres per hour (m³/hr). In some embodiments, the gaseous stream has a flow rate of less than 50,000, 40,000, 30,000, 20,000, 17,000, 15,000, 10,000, 9,000, 8,000, 7,000, 6,000, 5,000, 4,000, 3,000, 2,000, 1,000, 900, 800, 700, 600, 500, 400, 300, 200, 100, 90, 80, 70, 60, 50, 40, 30, 20, 10, 5, 1, 0.5, 0.1, 0.05, or 0.01 m³/hr. Combinations of these flow rates are also possible, for example between about 0.01 m³/hour to about 1500 m³/hour, between about 5 m³/hour to about 1000 m³/hour, between about 10 m³/hour to about 500 m³/hour, between about 20 m³/hour to about 200 m³/hour, between about 60 m³/hour to about 1000 m³/hour, between about 0.01 m³/hr to about 5,000 m³/hr, about 5,000 to about 40,000 m³/hr, about 7,000 m³/hr to about 30,000 m³/hr, or about 10,000 m³/hr to about 20,000 m³/hour.

In some embodiments, the gaseous stream or atmosphere has a higher flow rate. In some embodiments, the gaseous stream has a flow rate of at least 1, 5, 10, 20, 50, 100, 500, 1,000, 5,000, 7,000, 10,000, 15,000, 17,000, 20,000, 30,000, 40,000, or 50,000 cubic metres per hour (m³/hr). In some embodiments, the gaseous stream or atmosphere has a flow rate of less than 50,000, 40,000, 30,000, 20,000, 17,000, 15,000, 10,000, 7,000, 5,000, 1,000, 500, 100, 50, 20, 10, 5, or 1 m³/hr. Combinations of these flow rates are also possible, for example between about 5,000 m³/hr to about 40,000 m³/hr, about 7,000 m³/hr to about 30,000 m³/hr, or about 10,000 m³/hr to about 20,000 m³/hour. Other combinations with the lower flow rates described above are also possible, for example between about 100 cm³/min (0.006 m³/hr) to about 50,000 m³/hr or 100,000 cm³/min (6 m³/hr) to about 20,000 m³/hr.

In one embodiment, the process does not require a back pressure across the hydrogel.

In some embodiments, increasing the flow rate of the gaseous stream or atmosphere as it contacts the hydrogel leads to a faster rate of CO₂ absorption and capture in the hydrogel. For industrial scale applications, the flow rate of the gaseous stream may be up to 1000 m³/hour. In some embodiments, the gaseous stream has no flow rate (e.g. an ambient atmosphere).

The low CO₂ concentration gaseous stream or atmosphere may be at least partially dried to remove at least some of the moisture (H₂O) present in the gaseous stream prior to contacting with the hydrogel. For example, the gaseous stream may be dried to a humidity of less than 10%, 8%, 6%, 4%, or 2%, or to a humidity between any two of these values, for example between about 1% and about 10%, about 1% and about 5%, about 1% and about 3%. The gaseous stream or atmosphere may be dried by any conventional means (e.g. passing through a hygroscopic material or contacted with a source of heat) and its humidity measured via protocols as described herein.

In some embodiments, the low CO₂ concentration gaseous stream or atmosphere has an initial CO₂ concentration prior to contacting the hydrogel, and has a final CO₂ concentration after contacting the hydrogel (also referred to herein as an effluent gaseous stream and/or effluent CO₂ concentration). It will be appreciated that as CO₂ is absorbed into the hydrogel from the gaseous stream, the concentration of CO₂ in the effluent stream will be lower than the initial CO₂ concentration of the gaseous stream or atmosphere prior to contact (e.g. passing through) with the hydrogel.

The concentration of CO₂ in the gaseous stream or atmosphere can be measured by any suitable means, for example an isotopic analyser (e.g. using a G2201-i Isotopic Analyzer (PICARRO) and/or infrared spectrometer (e.g. an in-line calibrated cavity ring-down IR spectrometer). The concentration of CO₂ in the gaseous stream or atmosphere can be monitored by any suitable means, for example an SprintIR®-6S covering a range from 0-100% and K30 ambient sensor with a range of 0-1% CO₂.

### Methods for Acid Gas Capture/Release and Regeneration of Hydrogel

The acidic gas (e.g. CO₂) may be removed from the gaseous stream or atmosphere by being absorbed into a hydrogel. Accordingly, there is also provided a method for removing an acidic gas from a gaseous stream or atmosphere, comprising contacting the gaseous stream or atmosphere with the hydrogel to absorb at least some of the acidic gas from the gaseous stream or atmosphere into the hydrogel.

The hydrogel may, in one set of embodiments, be introduced into a gas flowline as a flow of particulate material. The hydrogel particulate can be provided in a packed bed with sufficient interstitial space between adjacent particles to allow a flow of gas therethrough.

The hydrogel will typically be used to absorb acid gas by passing a gaseous stream or atmosphere comprising the acidic gas through a chamber containing the hydrogel. The acidic gas is typically absorbed from a gaseous stream or atmosphere at a temperature and can be recovered from the hydrogel by changing the temperature and/or pressure, particularly by increasing the temperature.

Accordingly, in a further set of embodiments, there is provided a method for capture of acidic gas from a gaseous stream or atmosphere comprising: providing a chamber enclosing the hydrogel; passing a flow of the gaseous stream or atmosphere through the chamber and contacting the hydrogel to absorb at least some of the acidic gas into the hydrogel; and optionally heating the hydrogel to a temperature effective to desorb the absorbed acidic gas from the hydrogel; and optionally flushing the desorbed acidic gas from the chamber.

In some embodiments, the hydrogel is capable of absorbing between about 10 mg of acidic gas per g of hydrogel (mg/g) to about 300 mg/g acidic gas. In some embodiments, the hydrogel is capable of absorbing at least about 10, 20, 30, 40, 50, 60, 70, 80, 90, 100, 120, 150, 200, 250 or 300 mg/g acidic gas. In other embodiments, the hydrogel is capable of absorbing less than about 300, 250, 200, 150, 120, 100, 90, 80, 70, 60, 50, 40, 30, 20 or 10 mg/g acidic gas. Combinations of these absorption values are possible, for example the hydrogel is capable of absorbing between about 10 mg/g to about 80 mg/g acidic gas, between about 20 mg/g to about 70 mg/g acidic gas, or between about 100 mg/g to about 300 mg/g, or between about 200 mg/g to about 300 mg/g.

In some embodiments, the hydrogel is capable of absorbing between about 1% to about 20% wt. acidic gas. In some embodiments, the hydrogel is capable of absorbing at least about 1, 2, 3, 4, 5, 7, 10, 12, 14, 16, 18 or 20% wt. acidic gas. In some embodiments, the hydrogel is capable of absorbing less than about 20, 18, 16, 14, 12, 10, 7, 5, 4, 3, 2 or 1% wt. acidic gas. Combinations of these absorption values are possible, for example between about 1% to 10% wt. acidic gas. The present inventors have surprisingly identified that the alkanol functionalised hydrogels of the present disclosure can absorb a higher % wt. of acidic gas compared to hydrogels not functionalised with an alkanol. This is surprising particularly as the number of reactive amine sites decrease as a result of functionalisation (e.g. conversion of primary amines to secondary amines, and secondary amines to tertiary amines).

In some embodiments, at least about 10% of acidic gas is removed from the gaseous stream or atmosphere (e.g. at least about 10% of CO₂ is absorbed into the hydrogel from the gaseous stream or atmosphere). In some embodiments, at least about 10%, 25%, 50%, 75%, 90%, or 95% of acidic gas is removed from the gaseous stream or atmosphere.

The gaseous stream contacts the hydrogel (e.g. passes through a bed comprising the hydrogel) resulting in an effluent gaseous stream following contact with the hydrogel. As described above, before contact with the hydrogel, the gaseous stream has an initial acidic gas concentration. After contact with the hydrogel, the effluent gaseous stream has an effluent acidic gas concentration. The concentration of acidic gas in the effluent gaseous stream following contact with the hydrogel may be measured to determine the concentration of acidic gas remaining in the gaseous stream.

In some embodiments, over time, the concentration of acidic gas in the effluent gaseous stream following contact with the hydrogel may increase indicating reduced or no more acidic gas absorption is taking placed upon contact of the gaseous stream with the hydrogel (e.g. indicating the hydrogel is “saturated” (e.g. spent) and little to no more acidic gas absorption is occurring). This can act as an indicator to replace and/or regenerate the hydrogel to continue acidic gas capture. The concentration of acidic gas in the effluent gaseous stream may be measured by any suitable means, for example using an in-line calibrated cavity ring-down IR spectrometer.

In some embodiments, the hydrogel may be enclosed in a suitable chamber, wherein the chamber comprises one or more inlets through which the gaseous stream can flow to contact the hydrogel enclosed therein, and one or more outlets through which the effluent stream can flow out from the chamber. Alternatively, the hydrogel may be enclosed in a suitable chamber comprising one or more openings through which the gaseous stream can diffuse through (e.g. absent a back pressure/flow rate) to contact the hydrogel enclosed therein. It will be appreciated that the chamber can take a number of forms provided the gaseous stream can access the hydrogel. In one embodiment, the chamber may be a packed-bed column as described herein.

In some embodiments, the hydrogel may be provided as a bed, wherein the contacting of the gaseous stream or atmosphere with the hydrogel comprises passing the gaseous stream through the bed comprising the hydrogel. In one embodiment, the hydrogel is provided as a packed-bed reactor. In other embodiments, the contacting the gaseous stream or atmosphere with the hydrogel comprises introducing a flow of the hydrogel into the gaseous stream or atmosphere, for example using a fluidised bed reactor. In one embodiment, the chamber comprises a packed bed or fluidized bed of the hydrogel.

The hydrogel may be contacted with the gaseous stream for any suitable period of time, for example until the hydrogel is spent and no more acidic gas absorption is occurring. In one embodiment, the hydrogel is in contact with the gaseous stream until the concentration of acidic gas in the effluent gaseous stream is the same as the initial concentration of acidic gas of the gaseous stream. In some embodiments, the hydrogel is in contact with the gases stream for at least about 5, 10, 30, 60 seconds (1 minute), 10, 15, 20, 30, 45, 60 minutes (1 hour), 2, 5, 10, 24, 48 or 36 hours.

In some embodiments, the hydrogel provides various rates of acidic gas absorption. In one embodiment, the rate of acidic gas absorption can be measured by monitoring the acidic gas concentration of the effluent gaseous stream over time. For example, the concentration of acidic gas in the effluent gaseous stream may be less than about 50% of the initial acidic gas concentration after about 20 minutes of contact with the hydrogel. In some examples, the concentration of acidic gas in the effluent gaseous stream may be less than about 5% of the initial acidic gas concentration after about 100 seconds of contact with the hydrogel (in other words at least about 95% of acidic gas is removed from the gaseous stream after 100 seconds). Other rates of acidic gas absorption are also possible.

The acidic gas may be absorbed into the hydrogel at a wide range of temperatures depending on the specific application and/or gaseous stream/atmosphere. Generally speaking, the absorption of acidic gas is carried out at a temperature of no more than 70° C. such as no more than 60° C. The acidic gas may be desorbed from the hydrogel by heating the particles for example using a heated gas stream. Typically, the hydrogel will be heated to a temperature of at least 80° C. such as 80° C. to 110° C. or from 80° C. to 100° C. such as 80° C. to 95° C. or 80° C. to 90° C. The heating of the hydrogel may be carried out using heated gas such as air, steam or using other heating methods such as thermal radiation.

The acidic gas after absorption in the hydrogel can be released by breaking the bonds between the acidic gas and the amine groups (e.g. the bond between the CO₂ and amine). This can be achieved through using temperature (through heating) or pressure (through vacuum). This may involve heating the column containing the hydrogel or passing through a hot gas stream (e.g. steam) or hot air. Such desorption may be provided by any suitable environment capable of providing a heated environment (e.g. temperature) or a pressurised environment (e.g. through vacuum), or a combination thereof, in contact with or surrounding the hydrogel which can desorb at least some of the acidic gas absorbed within the hydrogel. Such desorption environment can operate in an “on” or “off” state. For example, once the concentration of acidic gas in the effluent gaseous stream following contact with the hydrogel has increased to a level indicating reduced or no more acidic gas absorption is taking place, the desorption environment may be switched “on” to desorb acidic gas from the hydrogel.

In some embodiments, at least 70%, 80%, 85%, 90%, 95%, 97%, 98% or 99% of the absorbed acidic gas is desorbed from the hydrogel.

### Acidic Gas Removal Apparatus

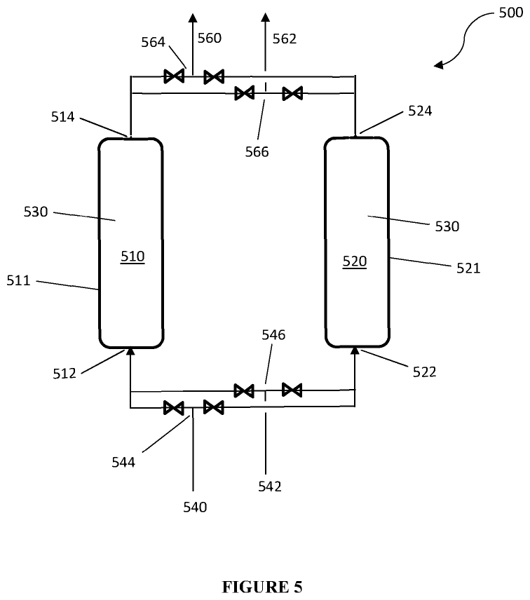

FIG. 5 depicts an apparatus 500 for performing the method for capture of an acidic gas from a gaseous stream or atmosphere, according to some embodiments or examples. Apparatus 500 includes first column 510 comprising chamber 511, gas inlet 512 and gas outlet 514, and second column 520 comprising chamber 521, gas inlet 522 and gas outlet 524. The chamber of each column is loaded with the hydrogel particulate 530, for example as a packed bed or fluidized bed. The hydrogel particulate 530 is a dry, free flowing powder of particles comprising an acid gas absorbent and hydrophobe as disclosed herein. Columns 510 and 520 are configured to be fed through their respective gas inlets with either gaseous stream or atmosphere 540 or flush gas 542 via gas manifolds 544 and 546. The gas effluent exiting the columns via their respective gas outlets are directed to either transfer line 560, for acidic gas lean gas, or transfer line 562, for acidic gas enriched gas, via gas manifolds 564 and 566.

In use, gaseous stream or atmosphere 540 is directed via manifolds 544, 546 to column 510 where it flows through chamber 511 and contacts the hydrogel particulate 530 therein. Gaseous stream or atmosphere 540 may, for example, contain CO₂ as the acidic gas to be captured. The acidic gas is absorbed into hydrogel particulate. The gas effluent leaving column 510 is thus depleted of at least a portion of the acidic gas, and is directed by gas manifolds 564, 566 to transfer line 560 which sends the acidic gas lean gas (treated gaseous stream or atmosphere 540) for further processing or atmospheric release.

After a period of time, the absorption capacity of acidic gas absorbent particulate 530 in column 510 will approach its maximum and the material must be regenerated to avoid unacceptable breakthrough of the acidic gas. Therefore, gaseous stream or atmosphere 540 is redirected via manifolds 544, 546 to column 520 where it flows through chamber 521 and contacts acidic gas absorbent particulate 530 therein. The gas effluent leaving column 520 is thus depleted of at least a portion of the acidic gas, and is directed by gas manifolds 564, 566 to transfer line 560.

While gaseous stream or atmosphere 540 is being processed in column 520, the composition 530 in column 510 is regenerated by heating the hydrogel particulate to a temperature sufficient to desorb the acidic gas from the particles. The desorbed acidic gas is then flushed from chamber 511 of column 510 with flush gas 542. The hydrogel particulate may be heated with flush gas 552, which is fed for contact with the composition at a suitably high temperature and/or by other conventional means of heating the particulate in a column. The gas effluent leaving column 510 is thus rich in acidic gas, and is directed by gas manifolds 564, 566 to transfer line 562 which sends the acidic gas enriched gas for storage or further processing. By switching the columns sequentially between absorption and desorption modes in this manner, acid gas 540 can be continuously processed to capture all or part of the acidic gas therefrom.

The disclosure thus also provides an acidic gas removal apparatus comprising a chamber enclosing a hydrogel as defined according to any one of the embodiments or examples described herein and/or prepared according to any one of the embodiments or examples described herein, wherein the chamber brings the gaseous stream or atmosphere into contact with the hydrogel to absorb at least some of the acidic gas into the hydrogel.

In one embodiment, the chamber of the acidic gas removal apparatus may comprise a packed bed or fluidized bed of the hydrogel.

In one embodiment, the chamber comprises an inlet through which gaseous stream or atmosphere can flow to the hydrogel and an outlet through which an effluent gaseous stream can flow out from hydrogel. The hydrogel may be located between the inlet and outlet of the chamber.

In some embodiments or examples, the apparatus may comprise two or more chambers enclosing the hydrogel in each chamber connected in parallel to the gaseous stream. The apparatus may comprise at least three chambers enclosing the hydrogel in each chamber, wherein each chamber may be connected in parallel to the gaseous stream. The hydrogel enclosed within the at least three chambers may be operated in different sections of the absorption and regeneration cycle to produce a continuous flow of the effluent gaseous stream.

Fluid flow is typically required to move the gaseous stream from the inlet of the chamber, across the hydrogel enclosed and out of the chamber through the outlet. The fluid flow may be driven by at least one fluid flow device which drives a fluid flow from the inlet to the outlet of the apparatus. A variety of different fluid flow devices can be used. In some embodiments or examples, the fluid flow device comprises at least one fan or pump. In some embodiments, or examples, the flow rate of the gaseous stream entering through the inlet, across the hydrogel, may be between about 0.01 m³/hr to about 50,000 m³/hr. The flow rate may be at least 0.01, 0.05, 0.1, 0.5, 1, 5, 10, 20, 30, 40, 50, 60, 70, 80, 90, 100, 200, 300, 400, 500, 600, 700, 800, 900 1,000, 2,000, 3,000, 4,000, 5,000, 6,000, 7,000, 8,000, 9,000, 10,000, 15,000, 17,000, 20,000, 30,000, 40,000, or 50,000 cubic metres per hour (m³/hr). In some embodiments, the gaseous stream has a flow rate of less than 50,000, 40,000, 30,000, 20,000, 17,000, 15,000, 10,000, 9,000, 8,000, 7,000, 6,000, 5,000, 4,000, 3,000, 2,000, 1,000, 900, 800, 700, 600, 500, 400, 300, 200, 100, 90, 80, 70, 60, 50, 40, 30, 20, 10, 5, 1, 0.5, 0.1, 0.05, or 0.01 m³/hr. Combinations of these flow rates are also possible, for example between about 0.01 m³/hr to about 5,000 m³/hr, about 5,000 to about 40,000 m³/hr, about 7,000 m³/hr to about 30,000 m³/hr, or about 10,000 m³/hr to about 20,000 m³/hour. The flow rate of the gaseous stream through the chamber and across the hydrogel may be achieved with substantially no back pressure measurable through or across the hydrogel. In an alternate embodiment or example, pressure variance or suction may be used to drive fluid flow of the gaseous stream through the device. For industrial scale applications, the flow rate of the gaseous stream may be up to 1000 m³/hour.

The chamber may have any suitable configuration. In some embodiments or examples, the chamber comprises an inlet at one end and an outlet at the opposite end. In an embodiment or example, a substrate, as described herein, can be located or otherwise packed within the chamber in a compacted manner to increase the surface area within that volume.

The apparatus may comprise a single or multiple chambers, wherein each chamber may enclose the hydrogel, as described herein. In some embodiments or examples, the apparatus may comprise two or more chambers enclosing a hydrogel in each chamber connected in parallel to the gaseous stream. In another embodiment or example, the apparatus may comprise at least three chambers enclosing the hydrogel in each chamber, wherein each chamber may be connected in parallel to the gaseous stream. In some embodiments or examples, the hydrogel enclosed within the at least three chambers may be operated in different sections of the absorption and regeneration cycle to produce a continuous flow of the effluent gaseous stream.

In some embodiments or examples, the process may be a cyclical method, where the steps of absorbing the acidic gas in the hydrogel enclosed by the chamber and releasing the acidic gas through operation of at least one desorption arrangement in a repetitive cycle so to continuously produce the effluent gaseous stream. The cycle time may depend on configuration of the apparatus, the configuration of the chamber(s), the type of desorption arrangement, the composition of the hydrogel, breakthrough point, saturation point and characteristics of the hydrogel, temperature, pressure and other process conditions. In some embodiments or examples, the cycle time may be about 10, 15, 20, 30, 45, 60 minutes (1 hour), 2, 5, 10, 24, 48 or 36 hours.

In some embodiments or examples, the desorption arrangement can take any number of forms depending on whether heat and/or reduced pressure is being used. In some embodiments or examples, the apparatus is designed for pressure swing absorption, with desorption being achieved by reducing the pressure for example using a vacuum pump to evacuate the gas from around the chamber enclosing the hydrogel. In other embodiments or examples, temperature swing absorption is undertaken to collect the acidic gas from the hydrogel. This can be achieved using direct heating methods.

In some embodiments or examples, the desorption arrangement may comprise a temperature swing absorption arrangement where the hydrogel is heated. For example, operating at least one desorption arrangement heats the hydrogel to a temperature of between about 20 to 140° C.

The present disclosure provides a process where a gaseous stream containing a concentration of acidic gas is fed into absorptive contact with the hydrogel, as described herein. After the hydrogel is charged with an amount of the acidic gas, the desorption arrangement is activated forcing at least a portion of the acidic gas to be released from the hydrogel. The desorbed hydrogel can be collected using a secondary process.

In other words, the effluent gaseous stream from the outlet can flow to a variety of secondary processes. For example, for carbon dioxide capture, the apparatus of the present disclosure can be integrated with a liquefier and/or dry ice pelletiser to provide dry ice on-demand. In another example, the apparatus of the present disclosure can be integrated with a hydrogenation apparatus to convert carbon dioxide (CO₂) to methane. In yet another example, the apparatus of the present disclosure may be used to adsorb carbon dioxide (CO₂) and store it for use at a different time. This would be applicable in a green-house type environment where CO₂ is absorbed at a particular time and used at a different time. In yet another example, the adsorption apparatus of the present disclosure may be particularly applicable for CO₂ in a confined space. For example, inside a submarine, space craft, air craft or other confined space like a room where the apparatus would be used to remove CO₂, and the apparatus capable of absorbing and desorbing CO₂ in a continuous cycle.

The apparatus of the present disclosure is advantageously compact and can be located much closer to end users, thereby allowing disruptive supply opportunities and better customer value.

The present application claims priority from AU2021902835 filed on 1 Sep. 2021, the entire contents of which are incorporated herein by reference.

### EXAMPLES

In order that the disclosure may be more clearly understood, particular embodiments of the invention are described in further detail below by reference to the following non-limiting experimental materials, methodologies and examples.

### General Materials

All chemicals are purchased from commercial sources and are used as supplied. Branched PEI (Mw ˜800), branched PEI (Mw ˜25,000) PEI solution (Mw ˜750,000, 50 wt. % in H₂O), monoethylene glycol (MEG), triglycidyl trimethylolpropane ether (TMPTGE or TTE, cross-linker), 1, 3-Butadiene diepoxide (BDDE, cross-linker) N-2-Hydroxyethyl(acrylamide) (97% with 1000 ppm MEHQ stabilizer), N,N′-methylenebis(acrylamide) (99%) N,N,N′,N′-tetramethyldiaminomethane (99%) and potassium persulfate (99%) were supplied by Sigma-Aldrich. Branched PEI (Mw ˜1,800) and branched PEI (Mw ˜10,000) were obtained from Alfa Aesar. Distilled water was used in the preparation of PEI solutions. Ambient air was used for the direct air capture studies.

### Example 1: Fabrication of Thermally Conductive PEI Hydrogels

To fabricate thermally conductive polyethylenimine hydrogel particles (“PEI Snow”), 9 g of PEI aqueous solution with concentrations ranging from 10 wt. % to 50 wt. % was added into a 20 mL plastic sample vial. Subsequently, graphite was added to the solution and stirred. Graphite particles (Sigma Aldrich, synthetic powder <20 μm) was added typically in amounts up to 4.5 g. Afterwards, 1 g of aqueous BDDE cross-linking solution with varying concentrations was also added into the same vial to initiate the PEI crosslinking at the ambient temperature. The crosslinking reaction terminated within 30 min depending on the PEI type and the amount of the cross-linker (BDDE) and eventually a bulk PEI gel was produced comprising graphite particles interspersed within the cross-linked PEI hydrogel. Afterwards, the PEI gel was vigorously ground using a glass stirring rod to obtain a snow-like material that had an average particle size of 200˜300 μm.

For the majority of the measurements, the thermally conductive PEI hydrogel was applied as prepared for the uptake measurements without being pre-treated or dried prior to use. As a result, the as prepared thermally conductive PEI hydrogel is swollen with water. A schematic of the thermally conductive PEI hydrogel preparation can be seen in FIG. 1.

For the materials that do not contain water as the liquid swelling agent, the same procedure was followed above, but the alternative liquid swelling agent was added by (1) drying the aqueous PEI using a vacuum oven and re-swelling in the target solvent; or (2) synthesizing the polymer in the alternative solvent so dissolving the starting materials in the target solvent.

Dry thermally conductive PEI hydrogels (i.e. no liquid swelling gent) were prepared by drying aqueous PEI snow prepared above in a vacuum oven to remove the water liquid swelling agent.

### Example 2: Fabrication of Thermally Conductive PHEAA Hydrogels

N-2-Hydroxyethyl(acrylamide) (Aldrich, 97% with 1000 ppm MEHQ stabilizer), N,N′-methylenebis(acrylamide) (Aldrich, 99%) N,N,N′,N′-tetramethyldiaminomethane (Aldrich, 99%) and potassium persulfate (Aldrich, 99%) were used as received from the supplier. In the case of a polyacrylamide/acrylic acid-based hydrogels described herein, the graphite can be added to the monomer/cross-linker aqueous solution with vigorous stirring prior to the addition of the free-radical polymer initiator and/or catalyst.

N-2-Hydroxyethylacrylamide (600 g, 5.21 mol) and N,N′-methylenebis(acrylamide) (120 g, 1.03 mol) were dissolved in water (1800 ml). Following dissolution, up to 360 grams of graphite powder is added. With vigorous stirring, under nitrogen, N,N,N′,N′-tetramethyldiaminomethane (1 ml, 6.68 mmol) was added followed by potassium persulfate (1 g, 3.7 mmol) to initiate polymerisation. Subsequently, the nitrogen stream was removed and the mixture was dried in an 80° C. oven for 24 hrs, ground to a powder, dried further for 48 hrs, ground again and sieved through a 425-micron metal sieve.

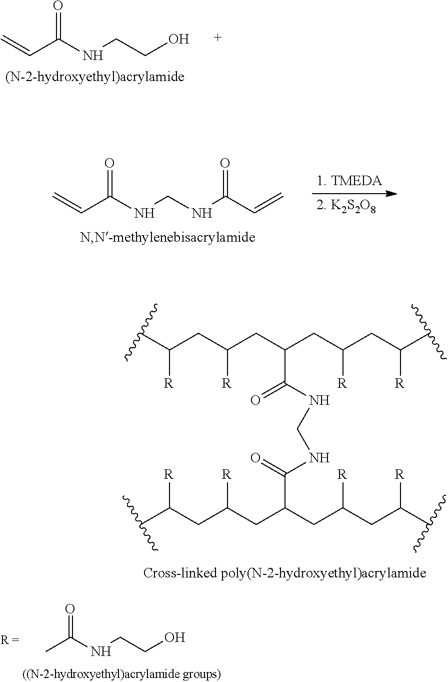

This PHEAA/graphite hydrogel can be then be combined with a number liquid swelling agents, including for example alkanolamines (e.g. diethanolamine) to form a CO₂ capture sorbent. Depending on the graphite loading and the sorbent powder size after sieving, increases in thermal conductivity of 3 to 8 can be measured compared to the thermal conductivity of the hydrogel without graphite particles.

### Example 3: Post-Addition of Graphite to Pre-Formed Hydrogel

The thermally conductive particulate material may be intercalated, interspersed or embedded onto the surface of the hydrogel. This can be accomplished by mixing preformed hydrogel particles (e.g. using the process of Example 1 or 2 without adding graphite to the solution prior to cross-linking) and graphite in a high speed blender for several minutes. The effective thermal conductivity of hydrogel particles alone is expected to be 0.05 to 0.06 W/mK while addition of 20% loading of graphite with mixing afterwards can yield an effective thermal conductivity of 0.15 W/mK.

### Example 4: Testing with CO₂ as a Capture Gas

The amine groups within the hydrogels (which are part of the hydrophilic polymer and/or part of the liquid swelling agent) are able to react with CO₂ generating a combination of carbamate, carbamic acid, carbonate/bicarbonate species thus immobilizing them and affording the material its sorbent characteristics. The CO₂ can then be concentrated by heating (i.e. a temperature swing) thus favouring its release from the sorbent. By improving the thermal conductivity of the hydrogel as described herein, the time required for the hydrogel can be reduced. Such improvements can provide one or more advantages such as ensuring the desorption occurs more uniformly due to uniform heat transfer throughout the hydrogel thus allowing for shorter thermal cycling times. Improving the thermal cycling times can also increase the throughput of the sorbent as well as improving the lifetime (i.e. the overall uptake amount over the life cycle of the sorbent).

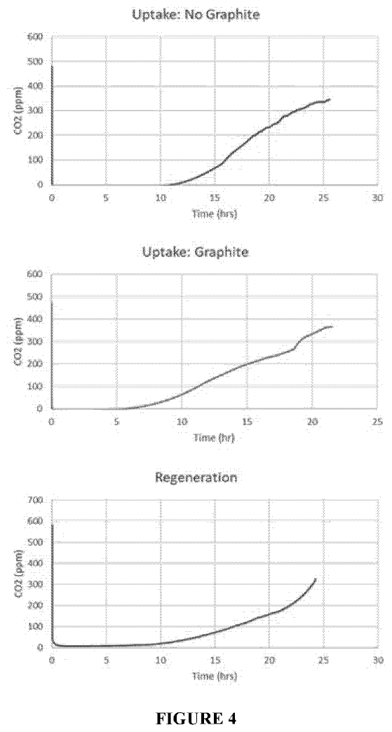

Referring to FIG. 4, the graph illustrates the outlet concentration of CO₂ with this reduced to zero for gas flowing through the material until breakthrough occurs. CO₂ uptake for thermally conductive PEI (middle) saturates more quickly with the outlet CO₂ concentration returning to the baseline more quickly compared to PEI hydrogel comprising no graphite (top). The thermally conductive hydrogel was regenerated at 90° C. in an oven for 12 hrs and the uptake was re-measured (bottom) and the uptake profile was the same as before which demonstrates that the presence of graphite does not substantially change the uptake.

It will be appreciated by persons skilled in the art that numerous variations and/or modifications may be made to the above-described embodiments, without departing from the broad general scope of the present disclosure. The present embodiments are, therefore, to be considered in all respects as illustrative and not restrictive.

1. A hydrogel for capture of acidic gas, comprising a cross-linked hydrophilic polymer and a thermally conductive particulate material, wherein the thermally conductive particulate material is interspersed on or within the hydrogel, wherein the hydrogel is in the form of a particulate and incorporates one or more acidic gas absorbents.

2. (canceled)

3. The hydrogel of claim 1, wherein the hydrogel comprises about 10% w/w to about 80% w/w of the thermally conductive particulate material based on the total weight of the hydrogel.

4. (canceled)

5. The hydrogel of claim 1, wherein the thermally conductive particulate material is a carbon based material selected from the group consisting of graphite, carbon black, carbon nanotubes, or carbon fibres.

6. (canceled)

7. The hydrogel of claim 1, wherein
a) the thermally conductive particulate material is chemically inert; and/or
b) the thermally conductive particulate material has a particle size of between about 1 μm to about 500 μm; and/or
c) the density of thermally conductive particulate material in the hydrogel is between about 10 to 100 particles/cm³ of hydrogel; and/or
d) the thermally conductive particulate material comprises between about 40% to about 90% of the total volume of the hydrogel.

8-10. (canceled)

11. The hydrogel of claim 1, wherein at least one acidic gas absorbent is incorporated within the hydrogel as one or more reactive functional groups on the cross-linked hydrophilic polymer for binding to the acidic gas.

12. The hydrogel of claim 1, wherein the hydrophilic polymer comprises a polyamine, a polyacrylamide, a polyacrylate, a polyacrylic acid, or a copolymer thereof.

13. The hydrogel of claim 12, wherein the polyamine is a polyalkylenimine.

14. The hydrogel of claim 13, wherein the polyalkylenimine is selected from the group consisting of polyethylenimine, polypropylenimine, and polyallylamine, or a copolymer thereof.

15-17. (canceled)

18. The hydrogel of claim 1, wherein the hydrogel is a self-supported hydrogel.

19. The hydrogel of claim 1, wherein the hydrogel comprises a liquid swelling agent absorbed within the hydrogel.

19-21. (canceled)

22. The hydrogel of claim 1, wherein the liquid swelling agent comprises an acidic gas absorbent for incorporating at least one acidic gas absorbent within the hydrogel.

23. The hydrogel of claim 22, wherein the liquid swelling agent comprises one or more functional groups capable of binding to the acidic gas by a chemical process or is a liquid capable of absorbing acidic gas by a physical process.

24. The hydrogel of claim 1, wherein the liquid swelling agent is selected from the group consisting of water, alcohols, polyol compounds, glycols, alkanolamines, alkylamines, alkyloxyamines, piperidines, piperazines, pyridines, pyrrolidones, and combinations thereof.

25-26. (canceled)

27. A process for preparing a hydrogel of claim 1, comprising mixing a solution comprising a hydrophilic polymer and a cross-linking agent under conditions effective to cross-link the hydrophilic polymer to form the hydrogel, and
wherein the process comprises mixing a particulate material having a thermal conductivity with the hydrophilic polymer and cross-linking agent or contacting the hydrogel with a particulate material under conditions effective to intersperse the particulate material on or within the hydrogel,
wherein the process further comprises grinding/crushing the hydrogel to form a particulate.

28-30. (canceled)

31. A method for removing an acidic gas from a gaseous stream or atmosphere, comprising contacting the gaseous stream or atmosphere with the hydrogel of claim 1 to absorb at least some of the acidic gas from the gaseous stream or atmosphere into the hydrogel.

32. (canceled)

33. The method of claim 31, wherein the gaseous stream or atmosphere is selected from the group consisting of combustion flue gas, a hydrocarbon gas, or hydro mixture, emission from cement or steel production, biogas and ambient air.

34. The method of claim 31, wherein the method is direct air capture (DAC).

35. The method of claim 31, wherein the contacting of the gaseous stream or atmosphere with the hydrogel comprises:
a) passing the gaseous stream or atmosphere through a bed comprising the hydrogel; or
b) introducing a flow of the hydrogel into the gaseous stream or atmosphere.

36-37. (canceled)

38. The method of claim 31, the method comprising:
providing a chamber enclosing the hydrogel;
passing a flow of the gaseous stream or atmosphere through the chamber and contacting the hydrogel to absorb at least some of the acidic gas into the hydrogel; and
optionally heating the hydrogel to a temperature effective to desorb the absorbed acidic gas from the hydrogel; and
optionally flushing the desorbed acidic gas from the chamber.

39. An acidic gas removal apparatus comprising a chamber enclosing a hydrogel for capture of acidic gas from a gaseous stream or atmosphere of claim 1, wherein the chamber brings the gaseous stream or atmosphere into contact with the hydrogel to absorb at least some of the acidic gas into the hydrogel.

40-41. (canceled)
